(19) United States
(12) Patent Application Publication
(10) Pub. No.: US 2026/0082041 A1
(43) Pub. Date: Mar. 19, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Junru LI, Beijing (CN); Chaoyi LIN, Beijing (CN); Yue LI, Los Angeles, CA (US); Kai ZHANG, Los Angeles, CA (US); Li ZHANG, Los Angeles, CA (US)

(21) Appl. No.: 19/399,028

(22) Filed: Nov. 24, 2025

Related U.S. Application Data
(63) Continuation of application No. PCT/CN2024/095040, filed on May 23, 2024.

(30) Foreign Application Priority Data
May 24, 2023 (WO) PCT/CN2023/095950

(51) Int. Cl. H04N 19/117; H04N 19/174; H04N 19/176; H04N 19/186

(52) U.S. Cl. CPC H04N 19/117; H04N 19/176; H04N 19/186; H04N 19/174

(57) ABSTRACT

Embodiments of the present disclosure provide a solution for video processing. A method for video processing is proposed. The method comprises: performing a conversion between a current video unit of a video and a bitstream of the video, wherein the bitstream comprises at least one indication indicating first information regarding a usage of a neural network (NN) based filter for the current video unit, and the NN-based filter is configured to process a luma component and a chroma component of the current video unit.

### CROSS REFERENCE TO RELATED APPLICATIONS

This application is a continuation of International Application No. PCT/CN2024/095040, filed on May 23, 2024, which claims the benefit of International Application No. PCT/CN2023/095950, filed on May 24, 2023. The entire contents of these applications are hereby incorporated by reference in their entireties.

### FIELDS

Embodiments of the present disclosure relates generally to video processing techniques, and more particularly, to neural network-based video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: performing a conversion between a current video unit of a video and a bitstream of the video, wherein the bitstream comprises at least one indication indicating first information regarding a usage of a neural network (NN) based filter for the current video unit, and the NN-based filter is configured to process a luma component and a chroma component of the current video unit.

Based on the method in accordance with the first aspect of the present disclosure, the NN-based filter is capable of processing both luma and chroma components and information regarding the usage of this NN-based filter is signaled. Compared with the conventional solution, the proposed method can advantageously enable flexible usage of the NN-based filter. Thereby, the coding efficiency can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: performing a conversion between a current video unit of the video and the bitstream, wherein the bitstream comprises at least one indication indicating first information regarding a usage of a neural network (NN) based filter for the current video unit, and the NN-based filter is configured to process a luma component and a chroma component of the current video unit.

In a fifth aspect, a method for storing a bitstream of a video is proposed. The method comprises: performing a conversion between a current video unit of the video and the bitstream, wherein the bitstream comprises at least one indication indicating first information regarding a usage of a neural network (NN) based filter for the current video unit, and the NN-based filter is configured to process a luma component and a chroma component of the current video unit; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRA WINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

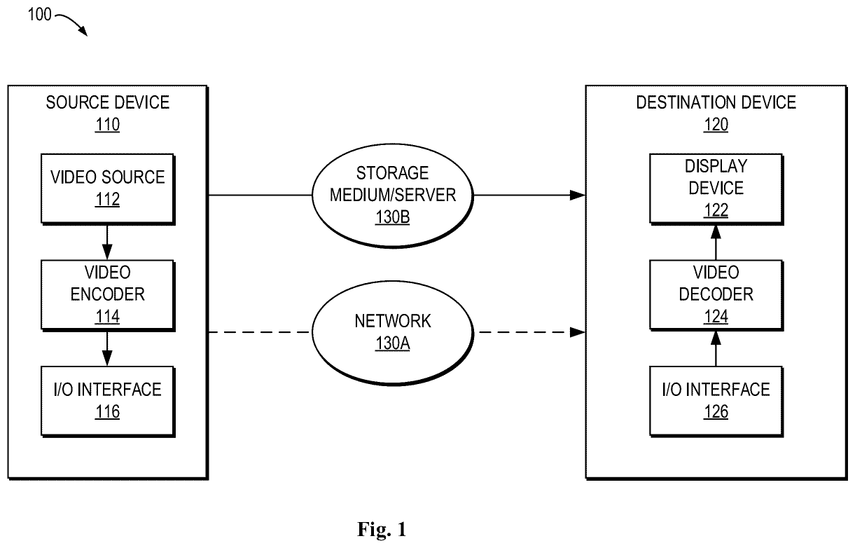

FIG. 1 illustrates a block diagram that illustrates an example video coding system, in accordance with some embodiments of the present disclosure;

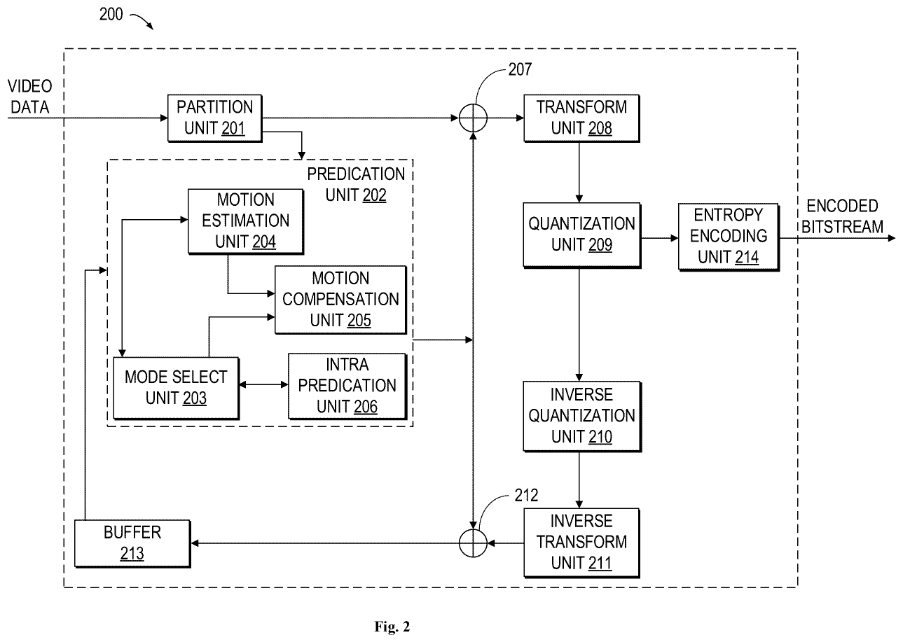

FIG. 2 illustrates a block diagram that illustrates a first example video encoder, in accordance with some embodiments of the present disclosure:

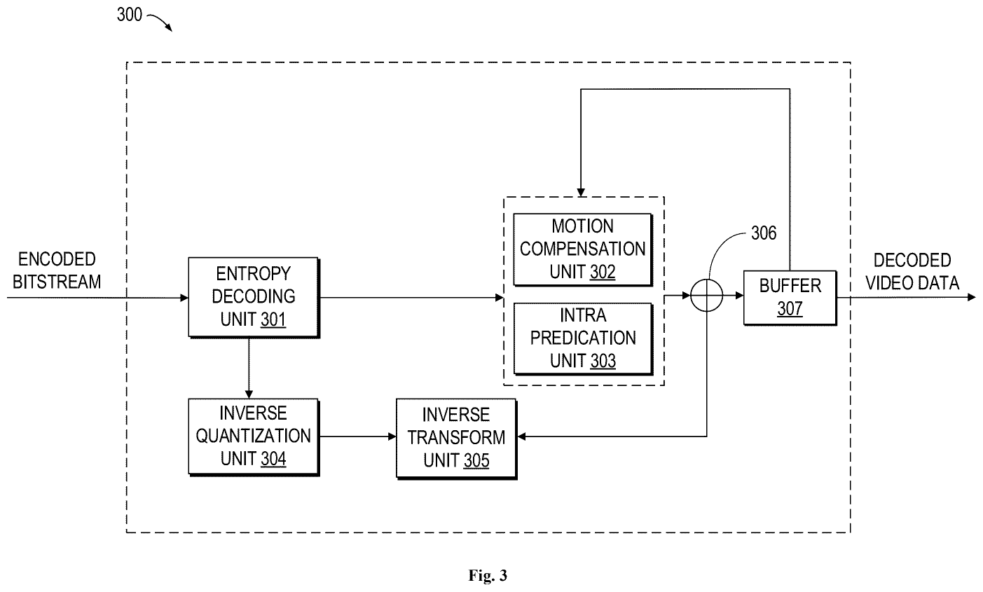

FIG. 3 illustrates a block diagram that illustrates an example video decoder, in accordance with some embodiments of the present disclosure:

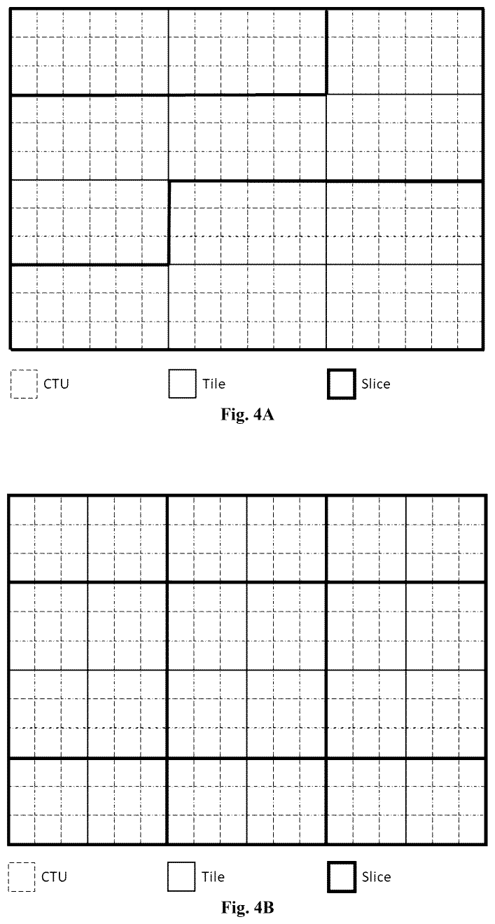

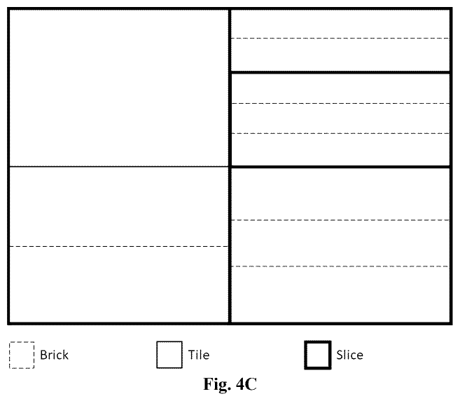

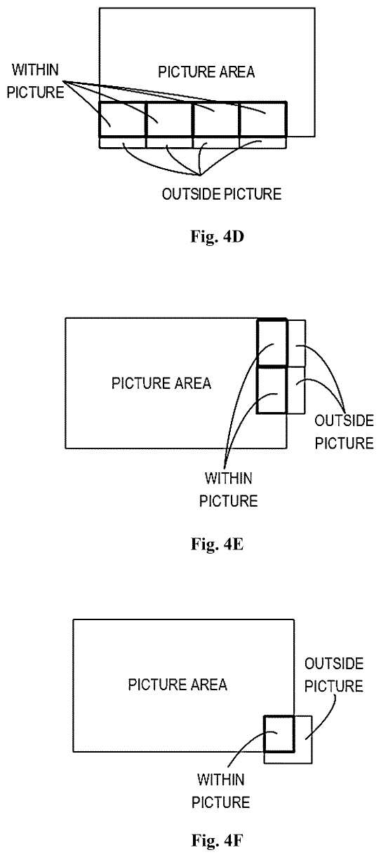

FIG. 4A shows an example of raster-scan slice partitioning of a picture:

FIG. 4B shows an example of a rectangular slice partitioning of a picture:

FIG. 4C shows an example of a picture partitioned into tiles, bricks, and rectangular slices:

FIG. 4D shows an example of CTBs crossing the bottom picture border:

FIG. 4E shows an example of CTBs crossing the right picture border:

FIG. 4F shows an example of CTBs crossing the right bottom picture border:

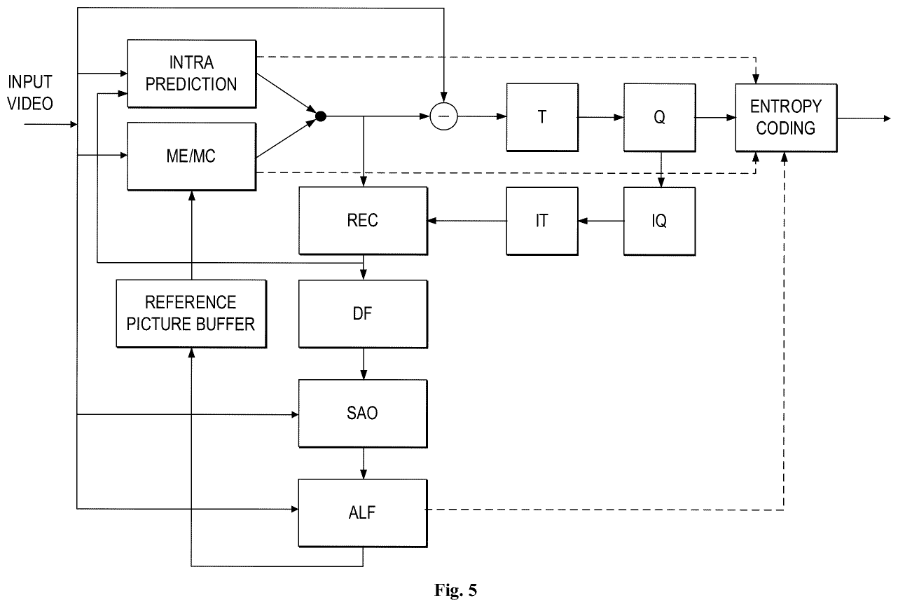

FIG. 5 shows an example of encoder block diagram;

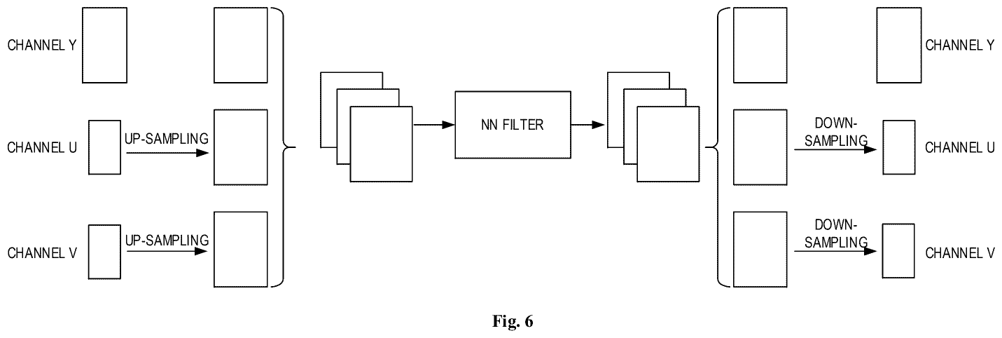

FIG. 6 illustrates an example of pre-processing and post-processing units:

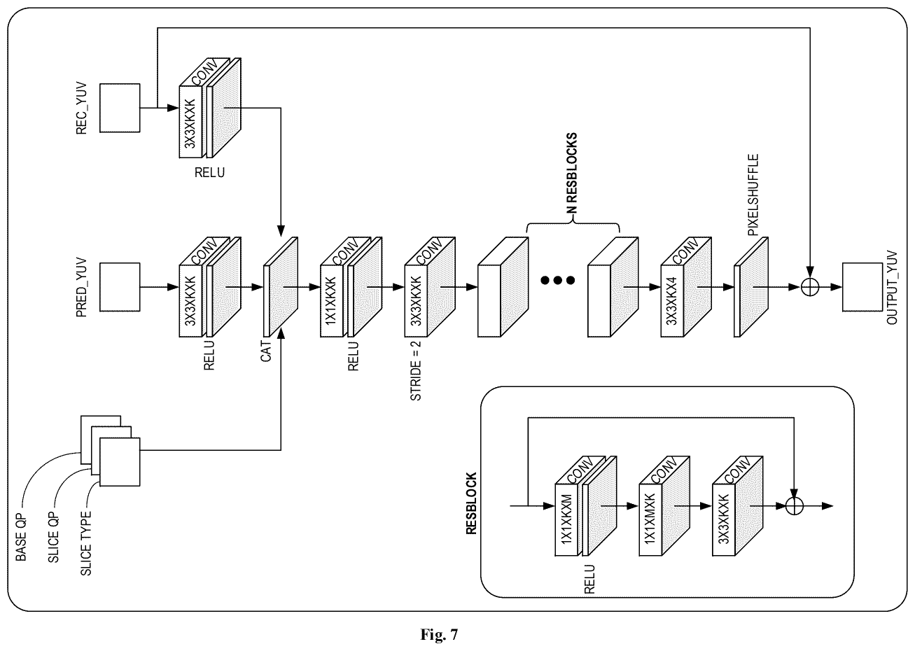

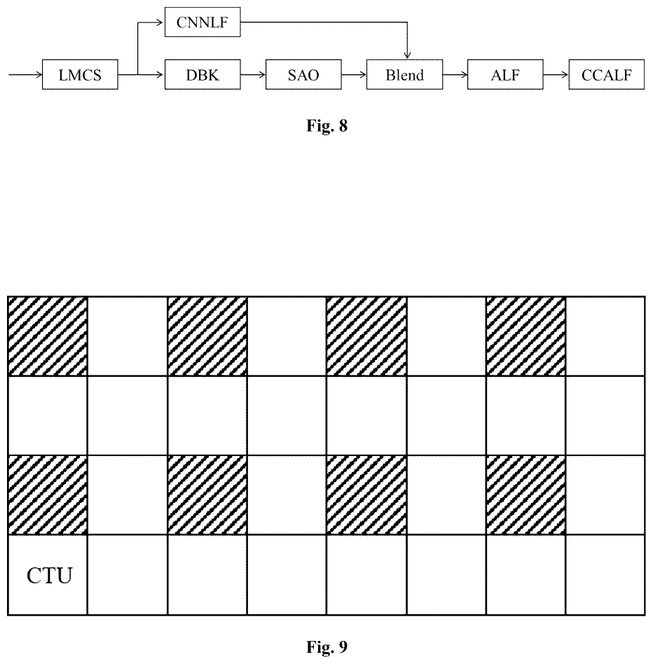

FIG. 7 illustrates an example architecture of the CNN in filter set 0:

FIG. 8 illustrates an example implementation of the CNN in filter set 0;

FIG. 9 illustrates an example encoder optimization:

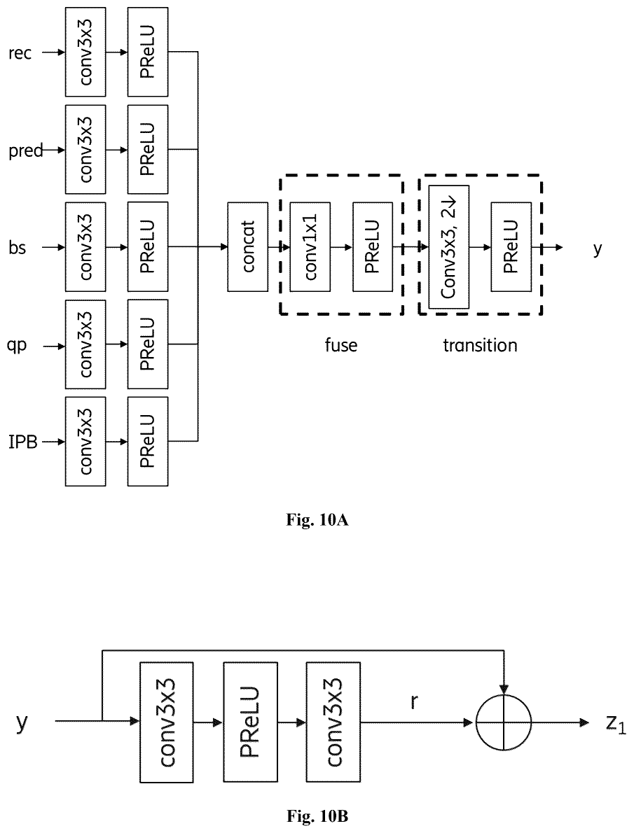

FIG. 10A illustrates an example head of luma network:

FIG. 10B illustrates an example subnetwork:

FIG. 10C illustrates another example subnetwork:

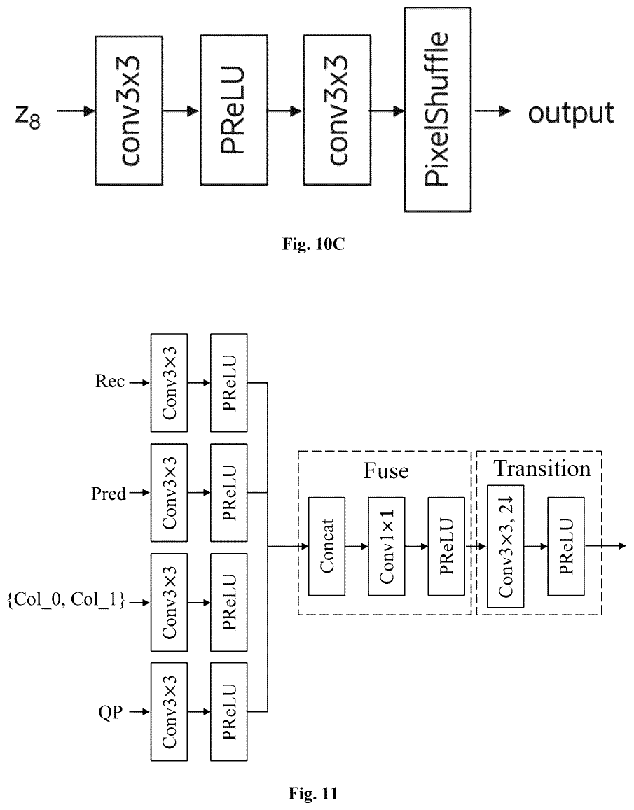

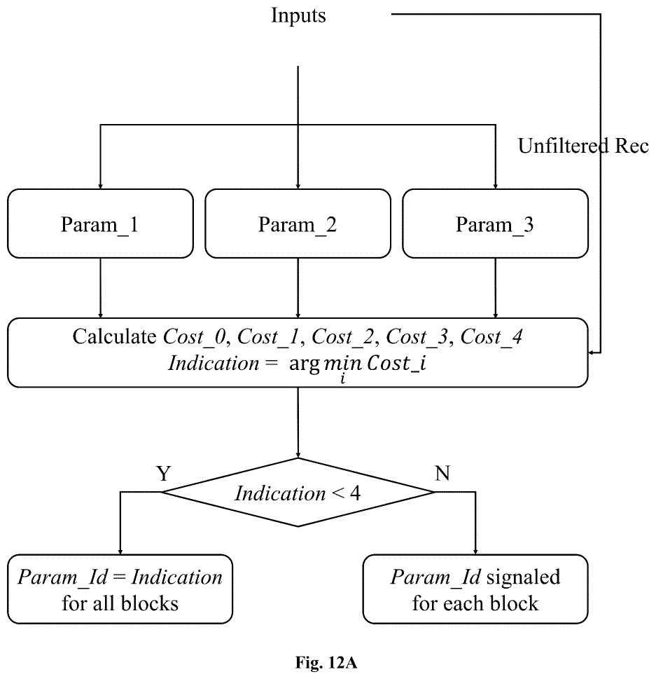

FIG. 11 illustrates an example temporal in-loop filter:

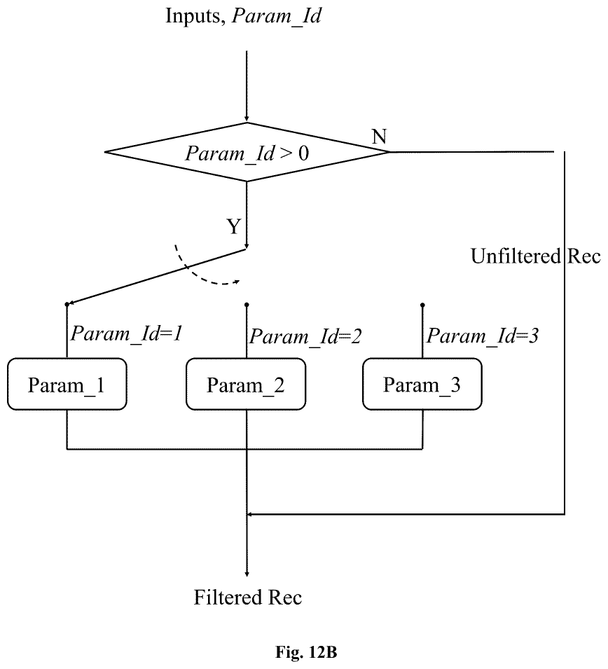

FIG. 12A illustrates an example parameter selection at an encoder side:

FIG. 12B illustrates an example parameter selection at a decoder side:

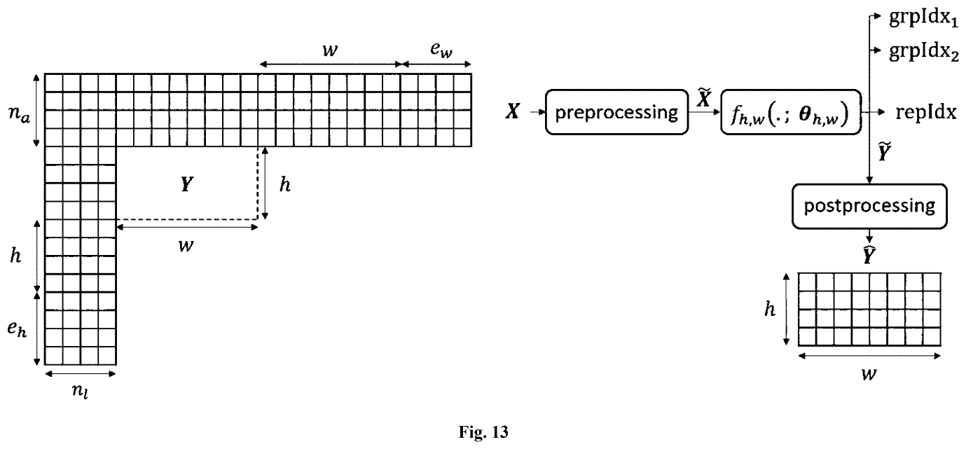

FIG. 13 illustrates prediction of a current block from a context of reference samples around the current block via the neural network-based intra prediction mode:

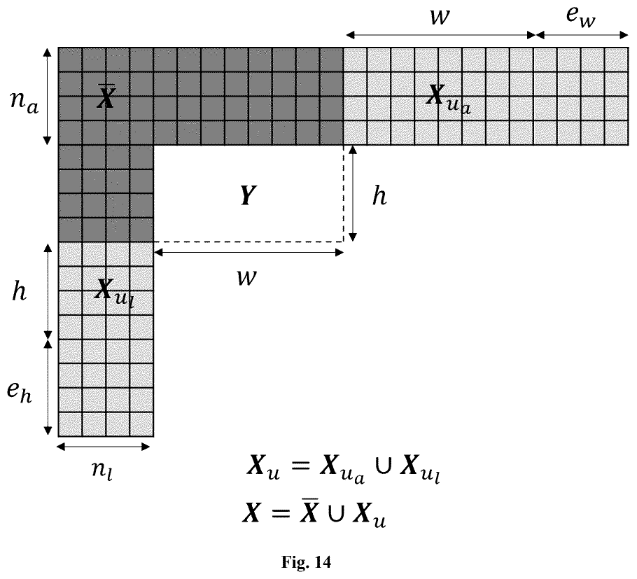

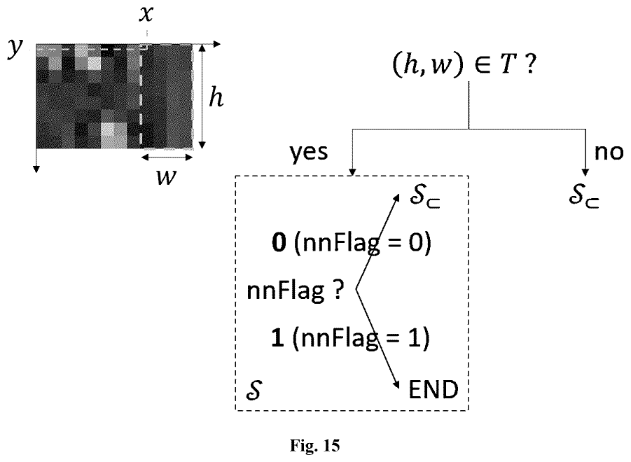

FIG. 14 illustrates decomposition of a context of reference samples surrounding the current block into the available reference samples and the unavailable reference samples:

FIG. 15 illustrates intra prediction mode signaling for the current luma CB framed in the dashed line;

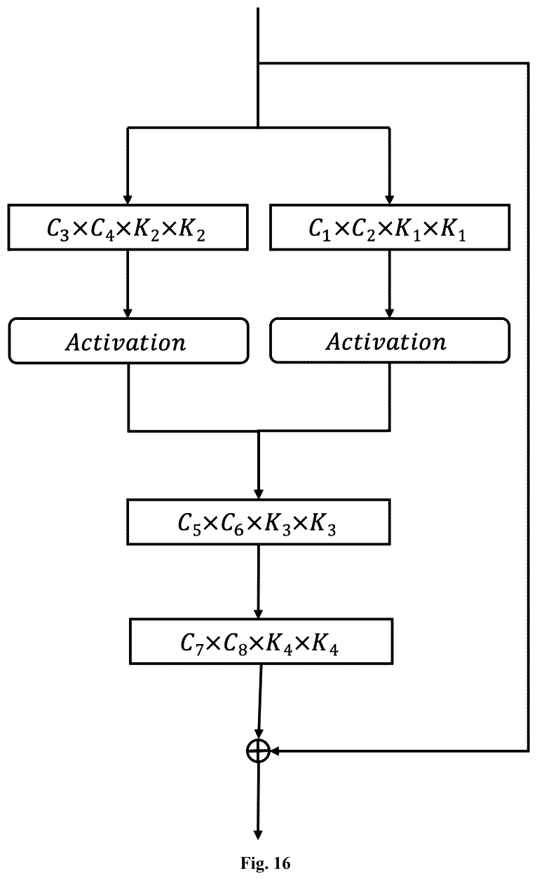

FIG. 16 illustrates an example multi-scale neural network with two branches for use in a NN-based loop filter:

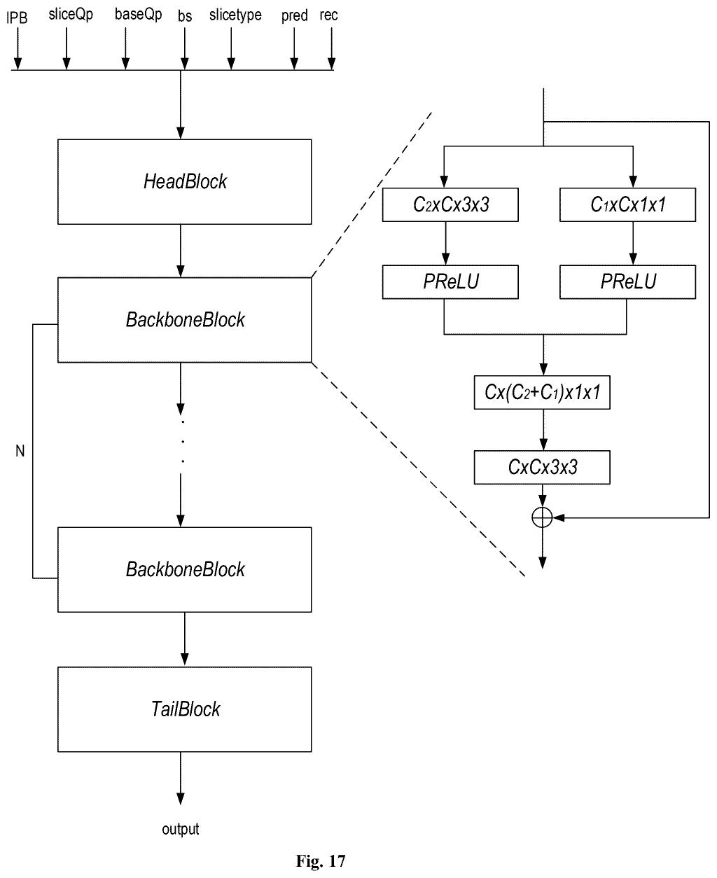

FIG. 17 illustrates an example network structure of NN filter in accordance with some embodiments of the present disclosure:

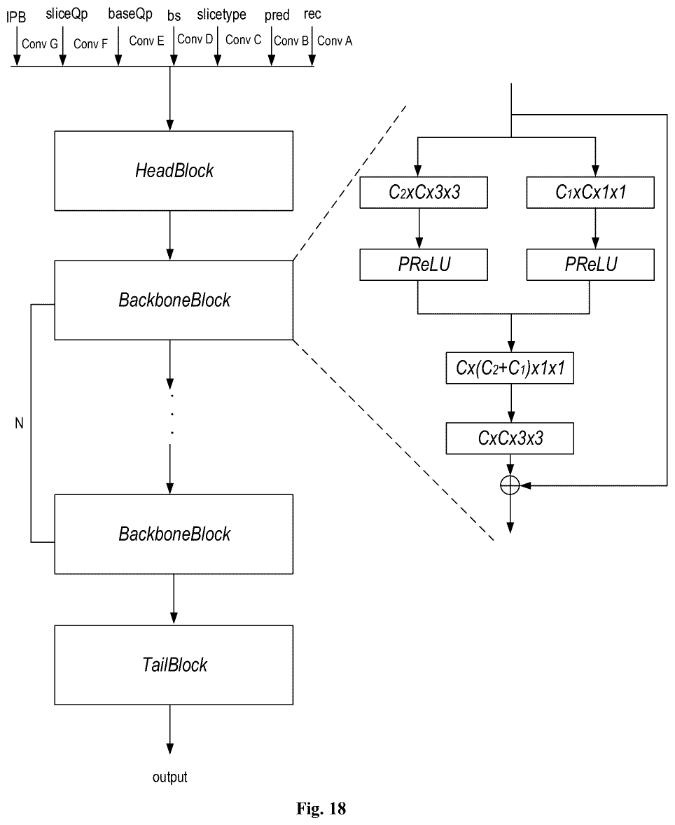

FIG. 18 illustrates an example network structure of NN filter in accordance with some embodiments of the present disclosure:

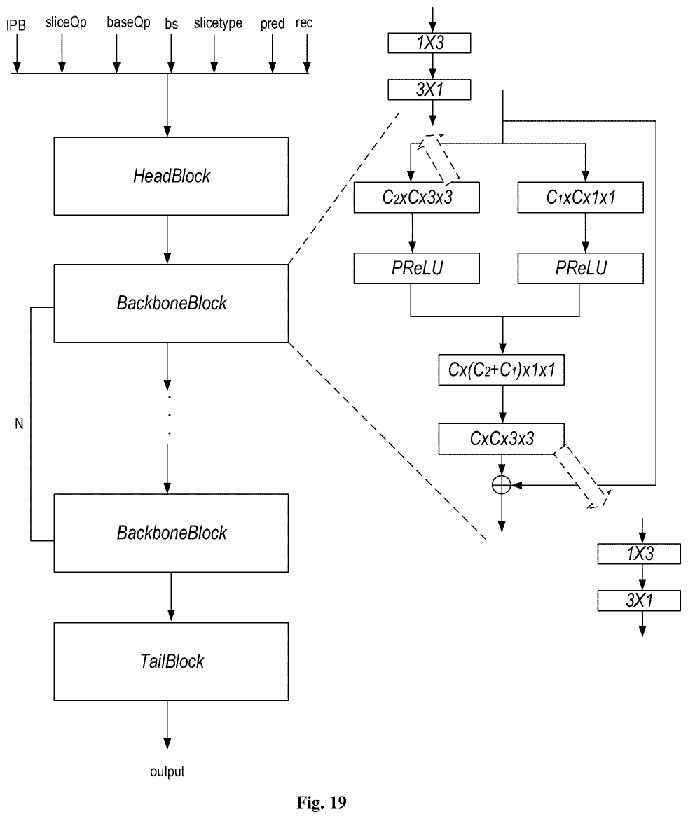

FIG. 19 illustrates an example network structure of NN filter in accordance with some embodiments of the present disclosure:

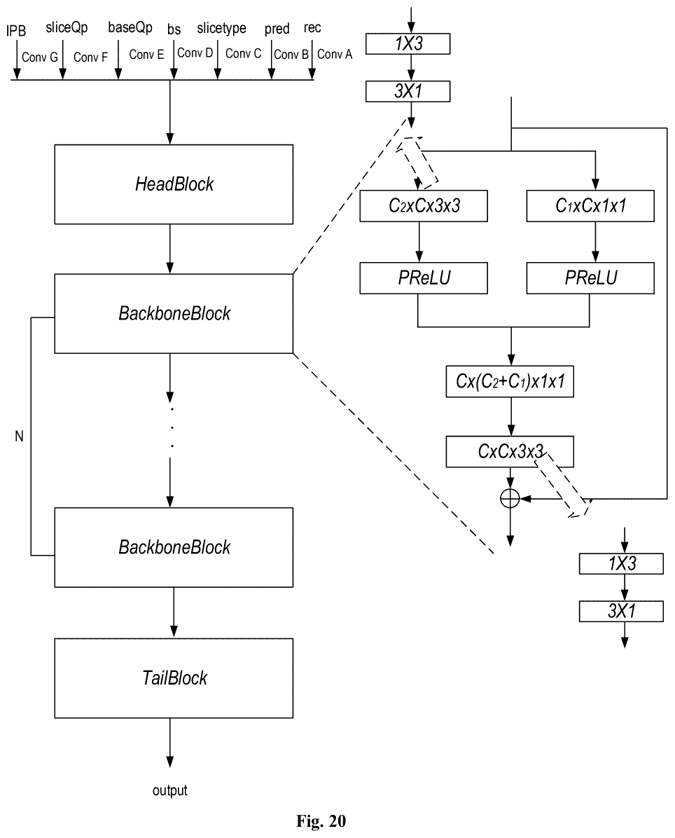

FIG. 20 illustrates an example network structure of NN filter in accordance with some embodiments of the present disclosure:

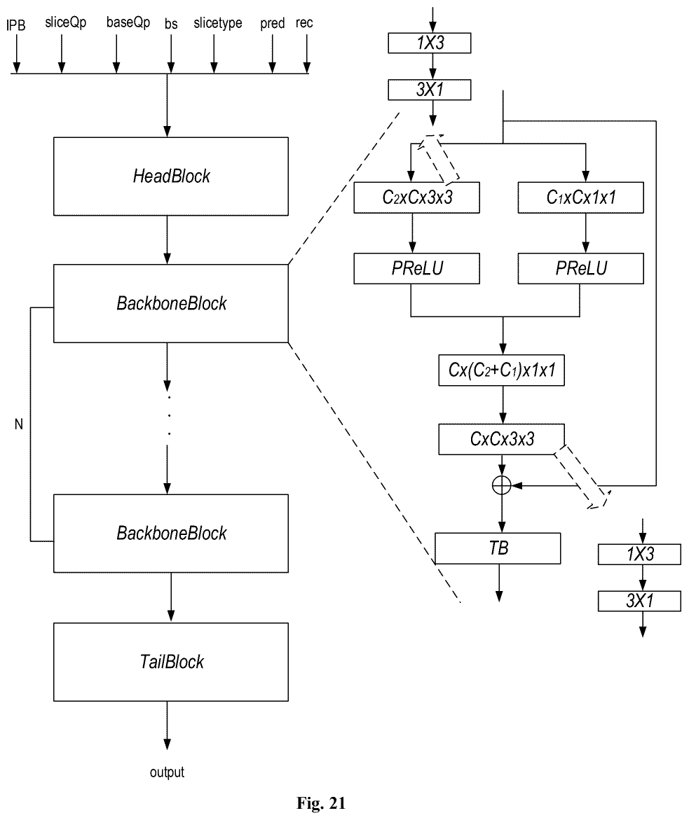

FIG. 21 illustrates an example network structure of NN filter in accordance with some embodiments of the present disclosure:

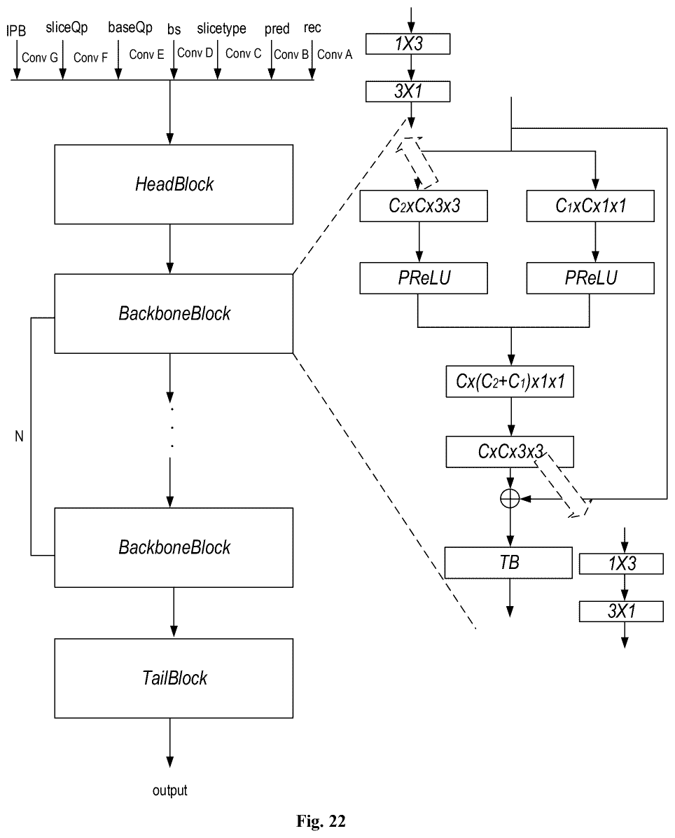

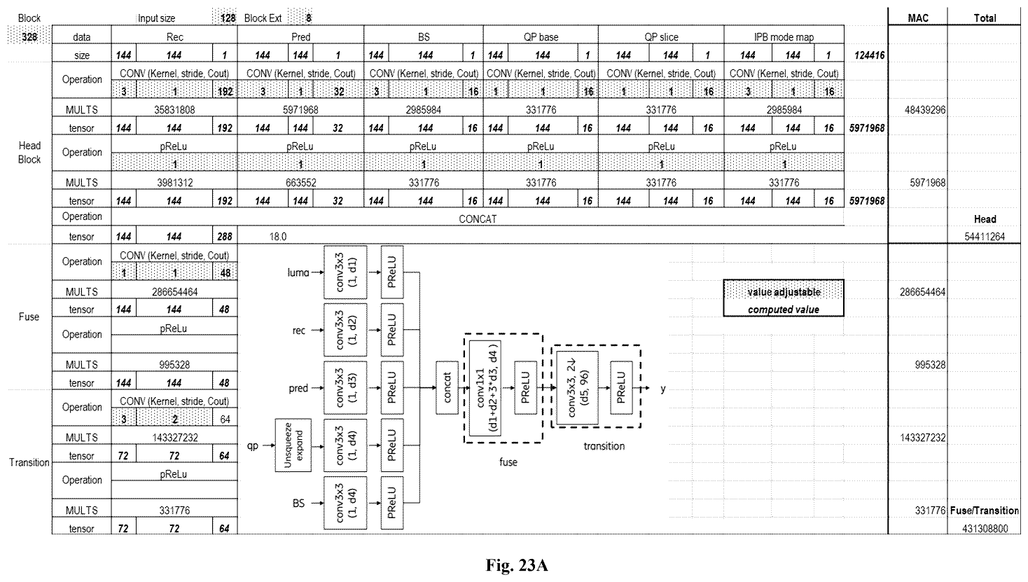

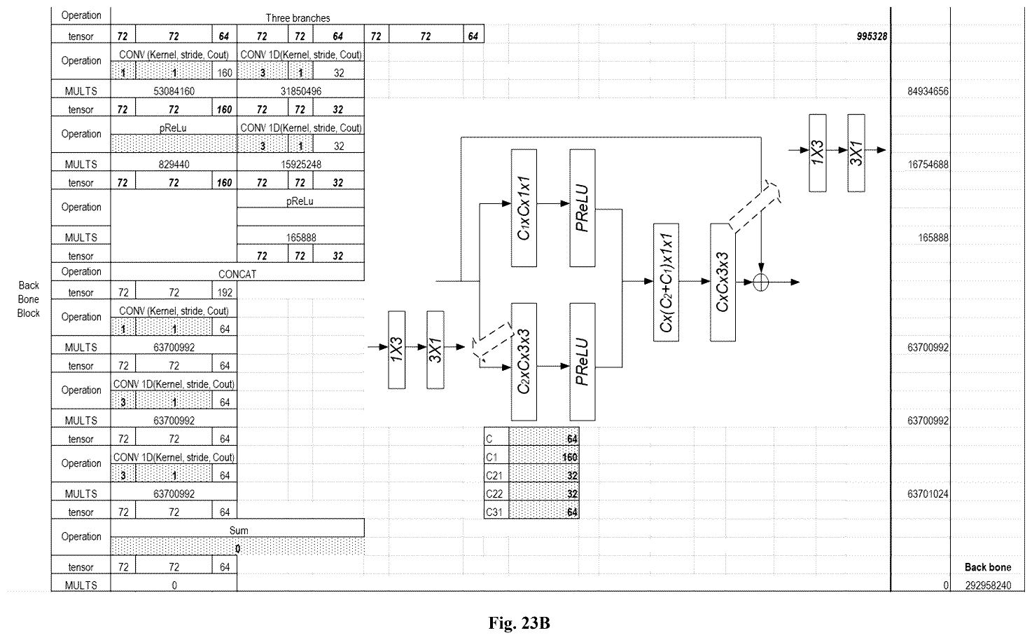

FIG. 22 illustrates an example network structure of NN filter in accordance with some embodiments of the present disclosure:

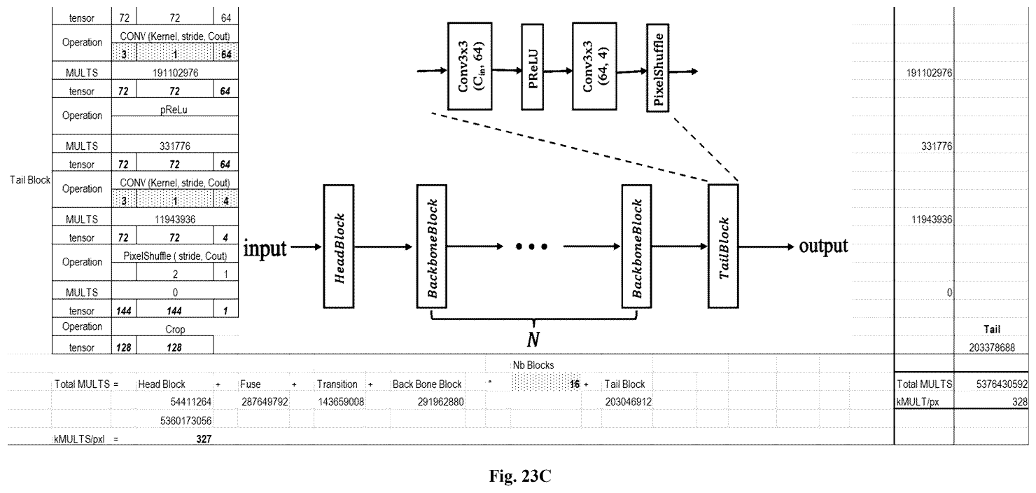

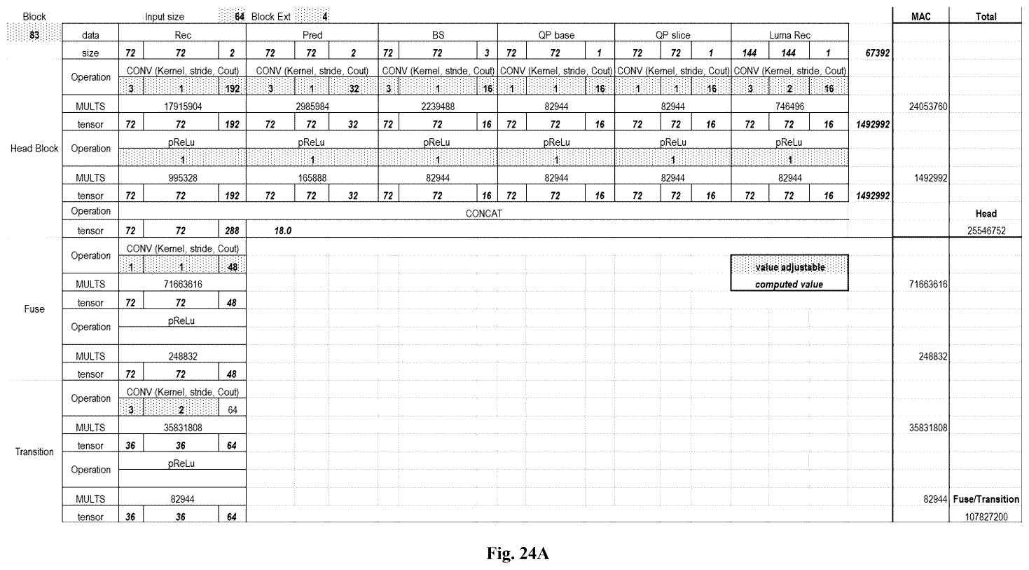

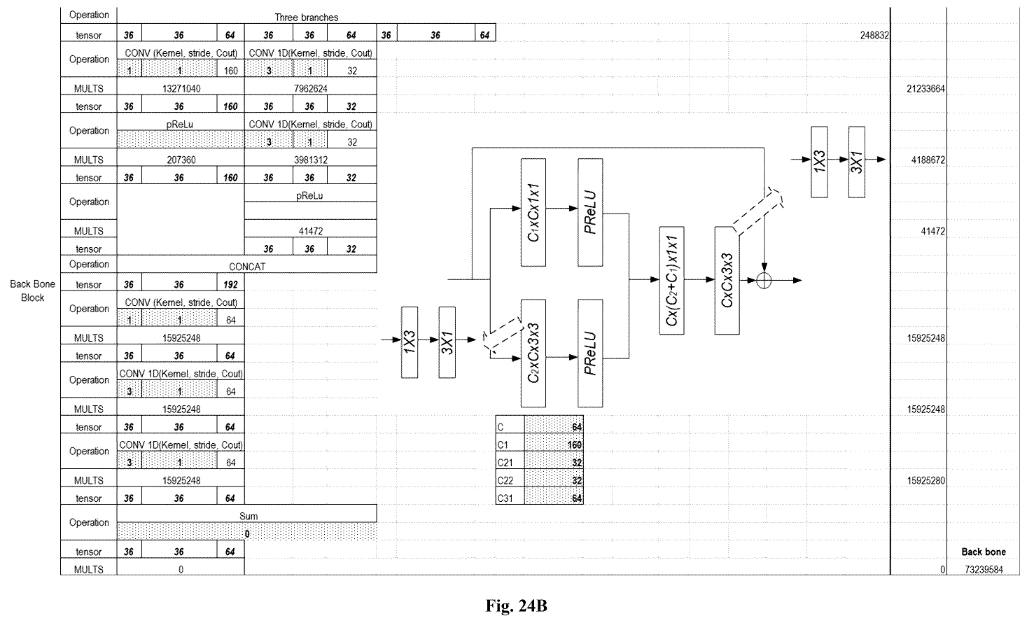

FIGS. 23A-23C illustrates an example structure and examples parameters of a luma model in accordance with some embodiments of the present disclosure:

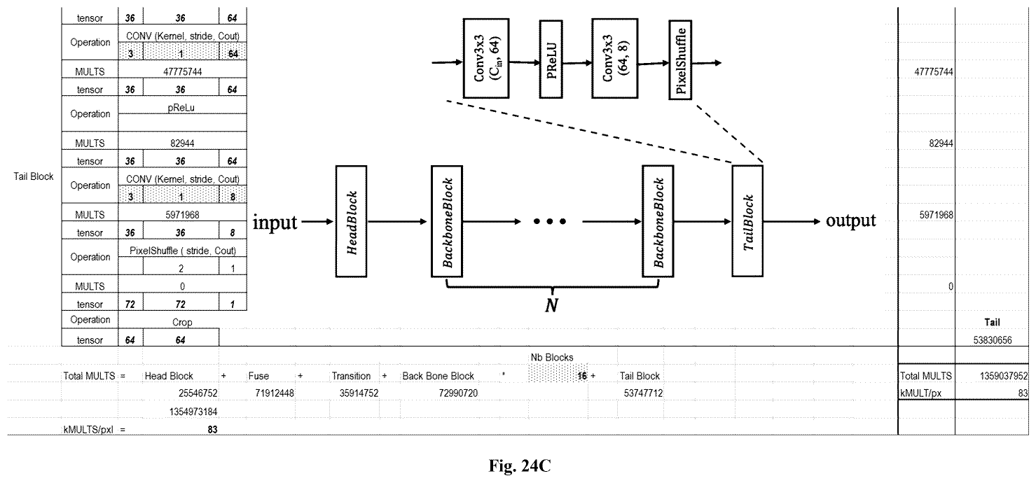

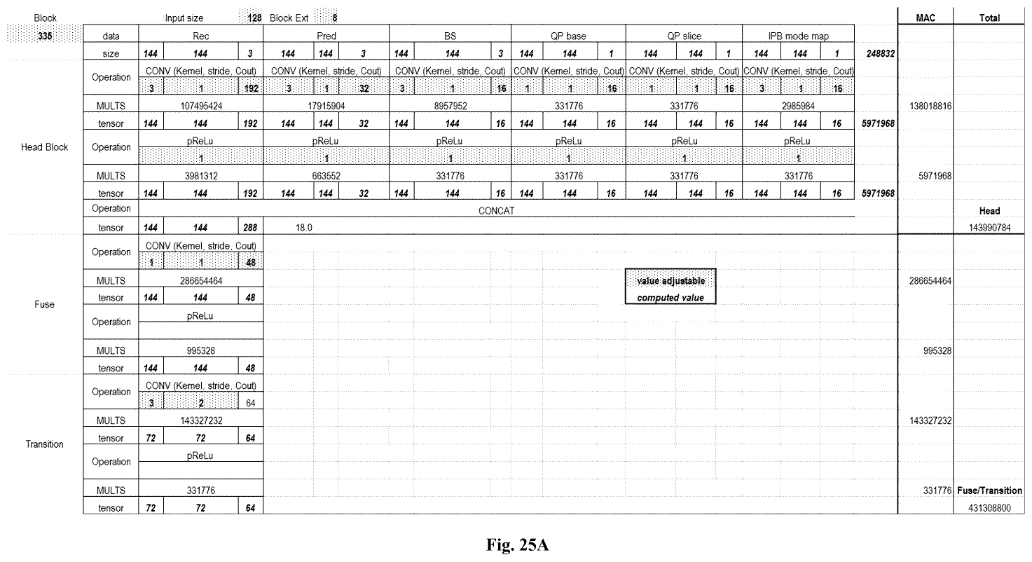

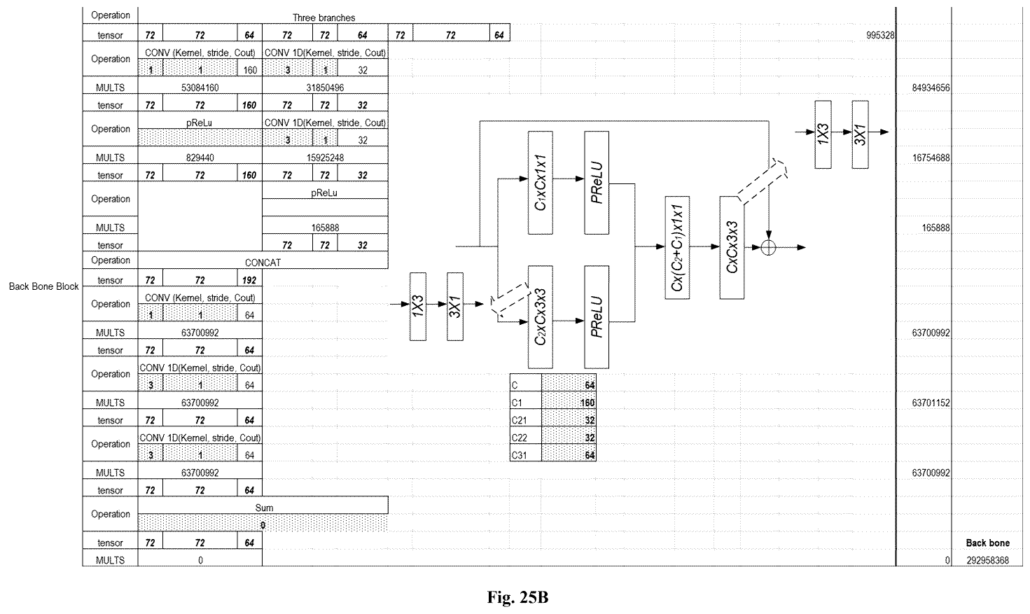

FIGS. 24A-24C illustrates an example structure and examples parameters of a chroma model in accordance with some embodiments of the present disclosure:

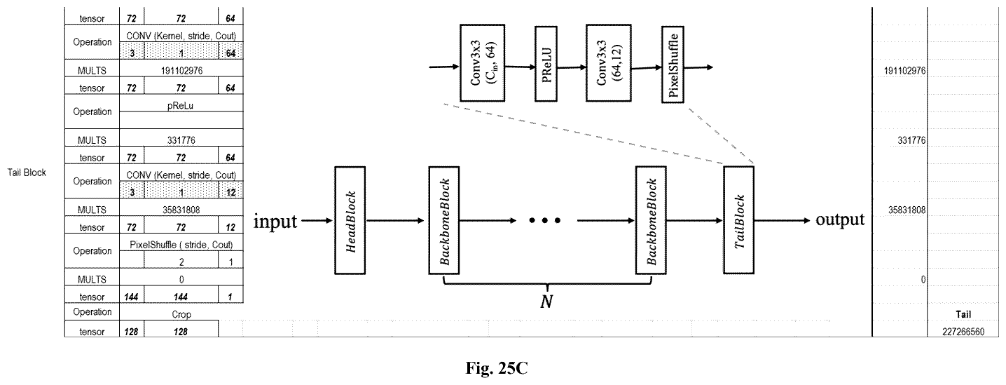

FIGS. 25A-25C illustrates an example structure and examples parameters of a single model for processing luma and chroma components in accordance with some embodiments of the present disclosure:

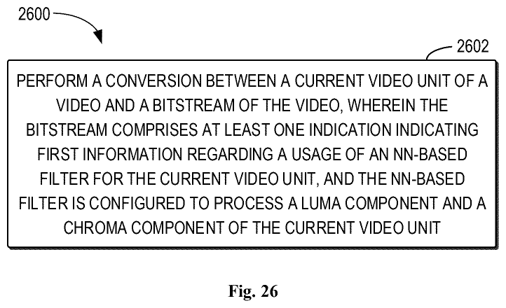

FIG. 26 illustrates a flowchart of a method for video processing in accordance with embodiments of the present disclosure; and

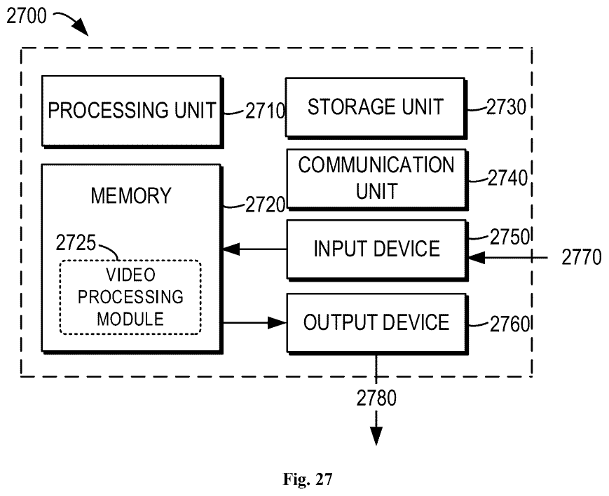

FIG. 27 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0) for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure.

In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes. i.e., de-quantizes, the quantized video block coefficients provided in the bitstream and decoded by entropy decoding unit 301. The inverse transform unit 305 applies an inverse transform.

The reconstruction unit 306 may obtain the decoded blocks. e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. 1. Initial Discussion

This patent document is related to video coding technologies. Specifically, it is related to the loop filter in image/video coding. The examples may be applied to video coding standard like High-Efficiency Video Coding (HEVC). Versatile Video Coding (VVC), or the standard to be finalized (e.g., third generation audio video standard (AVS3)). The examples may be also applicable to further video coding standards or video codec or be used as post-processing method which is outside of the encoding/decoding process.

### 2. 2. Further Discussion

Video coding standards have evolved primarily through the development of the well-known ITU-T and ISO/IEC standards. The ITU-T produced H.261 and H.263. ISO/IEC produced MPEG-1 and MPEG-4 Visual. and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC. Joint Video Exploration Team (JVET) was founded by VCEG and MPEG jointly in 2015. Since then, many new methods have been adopted by JVET and put into the reference software named Joint Exploration Model (JEM). The Joint Video Expert Team (JVET) between VCEG (Q6/16) and ISO/IEC JTC1 SC29/WG11 (MPEG) was created to work on the VVC standard targeting at 50% bitrate reduction compared to HEVC.

The Joint Video Exploration Team (JVET) of ITU-T VCEG and ISO/IEC MPEG is exploring potential neural network video coding technology beyond the capabilities of VVC. The exploration activities are known as neural network-based video coding (NNVC). The neural network-based (NN-based) coding tools are to enhance or replace conventional modules in the existing VVC design. The implementation of NN-based tools in NNVC 4 are based on Small Ad-hoc Deep Learning (SADL) library.

### 3. 2.1 Definitions of Video Units

A picture is divided into one or more tile rows and one or more tile columns. A tile is a sequence of CTUs that covers a rectangular region of a picture. A tile is divided into one or more bricks, each of which comprises a number of CTU rows within the tile.

A tile that is not partitioned into multiple bricks is also referred to as a brick. However, a brick that is a true subset of a tile is not referred to as a tile. A slice either contains a number of tiles of a picture or a number of bricks of a tile. Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture. The bricks within a rectangular slice are in the order of brick raster scan of the slice.

FIG. 4A shows an example of raster-scan slice partitioning of a picture, where the picture is divided into 12 tiles and 3 raster-scan slices. Specifically, FIG. 4A shows a picture with 18 by 12 luma CTUs that is partitioned into 12 tiles and 3 raster-scan slices.

FIG. 4B shows an example of a rectangular slice partitioning of a picture, where the picture is divided into 24 tiles (6 tile columns and 4 tile rows) and 9 rectangular slices. Specifically, FIG. 4B shows a picture with 18 by 12 luma CTUs that is partitioned into 24 tiles and 9 rectangular slices.

FIG. 4C shows an example of a picture partitioned into tiles, bricks, and rectangular slices, where the picture is divided into 4 tiles (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices. Specifically, FIG. 4C shows a picture that is partitioned into 4 tiles, 11 bricks, and 4 rectangular slices.

### 4. 2.1.1 CTU/CTB Sizes

In VVC, the CTU size, signaled in SPS by the syntax element log2_ctu_size_minus2, could be as small as 4×4.

### 5. 2.1.2 CTUs in a Picture

Suppose the CTB/LCU size indicated by M×N (typically M is equal to N, as defined in HEVC/VVC), and for a CTB located at picture (or tile or slice or other kinds of types, picture border is taken as an example) border, K×L samples are within picture border wherein either K<M or L<N. For those CTBs as depicted in FIGS. 4D-4F, the CTB size is still equal to M×N, however, the bottom boundary/right boundary of the CTB is outside the picture.

FIG. 4D shows an example of CTBs crossing the bottom picture border. FIG. 4E shows an example of CTBs crossing the right picture border. FIG. 4F shows an example of CTBs crossing the right bottom picture border. Accordingly, FIGS. 4D-4F show examples of CTBs crossing picture borders, where in FIG. 4D K=M, L<N: in FIG. 4E K<M, L=N: in FIG. 4F K<M, L<N.

### 6. 2.2 Coding Flow of a Typical Video Codec

FIG. 5 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signaling the offsets and filter coefficients. ALF is located at the last processing stage of each picture and can be regarded as a tool trying to catch and fix artifacts created by the previous stages.

### 7. 2.3 Neural Network-Based Video Coding (NNVC)

### 8. 2.3.1 Neural Network-Based Loop Filter Set 0

### 9. 2.3.1.1 Pre-Processing and Post-Processing of Chroma

FIG. 6 illustrates an example of pre-processing and post-processing units. In filter set 0, the filter with a single model is designed to process three components. Since the resolutions of luma and chroma are different, pre-processing and post-processing steps are introduced to up-sample and down-sample chroma components respectively as shown in FIG. 6. In the resampling process, the nearest-neighbor interpolation method is used.

### 10. 2.3.1.2 Neural Network

FIG. 7 illustrates an example architecture of the CNN in filter set 0. The network structure of the CNN filter is shown in FIG. 7. Along with the reconstructed image (rec_yuv), additional side information is also fed into the network, such as the prediction image (pred_yuv), slice QP, base QP and slice type. In the ResBlock, the number of channels firstly goes up before the activation layer, and then goes down after the activation layer. Specifically, K and M are set to 64 and 160 respectively, and the number of Resblock is set to 32.

11. 2.3.1.3. Combination with Conventional Filters

FIG. 8 illustrates an example implementation of the CNN in filter set 0.As shown in FIG. 3, the reconstructed samples before DBK are fed into the CNN based filter (CNNLF), then final filtered samples are generated by blending the result of CNNLF and SAO. This blending process can be briefly formulated as:

$${R}_{B l e n d} = w \times {R}_{NN} + ( 1 - w ) \times {R}_{SAO}$$

There are four candidates, 1, 0.75, 0.5 and an adaptive weight, for the blending weight. With regard to the adaptive weight, its derivation is based on least square method. If the adaptive weight is selected, the blending weight is signaled for each color component in the slice header.

### 12. 2.3.1.4. Mode Selection

The CNN filter can be turned on/off at the CTU level and slice level. For each enabling type, there are four blending ways. Therefore, there are nine modes to be evaluated by RDO at encoder. The final selected mode would be signaled in the slice header.

TABLE 1
Parameter selection of filter set 0

| Mode | On/off type | Blending weight (w) |
|---|---|---|
| 0 | Disable at slice level | None |
| 1 | Enable at slice level | Adaptive weight |
| 2 | | 1 |
| 3 | | 0.75 |
| 4 | | 0.5 |
| 5 | Enable at CTU level | Adaptive weight |
| 6 | | 1 |
| 7 | | 0.75 |
| 8 | | 0.5 |

### 13. 2.3.1.5 Base QP Adjustment

Base QP is fed into the CNN filter as shown in FIG. 8. To improve adaptation, an offset can be added to the base QP (the adjusted base QP is used as the input to the NN filter) at slice level. The offset candidates are {−5, 5}. For example given the offset−5, the actual input base QP to the filter becomes (BaseQP −5) for the current slice.

### Encoder Approach

FIG. 9 illustrates an example encoder optimization. An example encoder only filters one out of every four CTUs during the process of selecting the best base QP offset to save encoding time. As shown in FIG. 9, only shaded CTUs are considered for calculating distortions of using different BaseQP candidates {BaseQP, BaseQP−5, BaseQP+5}. After the candidate with the smallest cost is selected, the encoder filters the rest of CTUs (non-shaded ones in FIG. 9) by applying the best offset to the base QP.

### 14. 2.3.1.6. Encoder-Only Optimization

To more accurately estimate the rate-distortion (RD) cost with integrated NN-based in-loop filters, an encoder-only NN filter is involved in the partitioning decision process. In the partitioning mode decision, the distortion between NN filtered samples and original samples is calculated, and then the optimal partitioning mode is selected based on calculated distortion to make the partitioning decision more accurate. To reduce complexity, only few ResBlocks (see Section 3.1.2.) are used in the network structure. The NN filter in the RDO process is implemented with SADL using int16 precision. This encoder-only NN tool is disabled by default.

### 15. 2.3.1.7 Inference Details

SADL is used for performing the inference of the CNN filters. Both floating point-based and fixed point-based implementations are supported. In the fixed-point implementation, both weights and feature maps are represented with int16 precision using a static quantization method. The network information in the inference stage is provided in Table 2.

TABLE 2
Network Information of filter set 0 in Inference Stage
Network Information in Inference Stage

| Mandatory | HW environment: | |
|---|---|---|
| | GPU Type | N/A |
| | Framework: | SADL |
| | Number of GPUs per Task | 0 |
| | Number of Parameters (Each Model) | 1.9M |
| | Total Parameter Number | 1.9M, one model in total |
| | Parameter Precision (Bits) | float: 32 |
| | | int: 16 |
| | Memory Parameter (MB) | float: 7.6MB, one model in total |
| | | int: 3.8MB, one model in total |
| | Multiply Accumulate (kMAC/pixel) | 485 (assuming frame-level input) |
| | | 615 (assuming block-level input) |
| Optional | Total Conv. Layers | 101 |
| | Total FC Layers | 0 |
| | Total Memory (MB) | |
| | Batch size: | 1 |
| | Patch size | 144 × 144 |
| | Changes to network configuration or weights | |
| | required to generate rate points | |
| | Peak Memory Usage | |
| | Other information: | |

### 16. 2.3.2. Neural Network-Based Loop Filter Set 1

### 17. 2.3.2.1. Neural Network for Luma Component

FIGS. 10A-10C illustrate an example architecture of the CNN in filter set 1. FIG. 10A illustrates an example head of luma network. The inputs are combined to form the input y to the next part of the network. FIG. 10B illustrates an example subnetwork. The k-th residual block (k=0 . . . 7). The output y of the head is fed into a first residual block with input z0=y. The output z1 is then fed into another such residual block. FIG. 10C illustrates another example subnetwork. The output of the last residual block is fed into this last part of the network.

There are two regular networks in filter set 1, one for luma and one for chroma. The inputs of the luma network comprise the reconstructed luma samples (rec), the prediction luma samples (pred), boundary strengths (bs), QP, and the block type (IPB). The numbers of feature maps and residual blocks are set as 96 and 8 respectively. The structure of the luma network is depicted in FIG. 10A-10C.

### 2.3.2.23 Neural Network for Chroma Component

Luma information is taken as additional input for the in-loop filtering of chroma. Considering the resolution of luma is higher than chroma in YUV 4:2:0 format, features are first extracted separately from luma and chroma. Then luma features are down-sampled and concatenated with chroma features. The inputs of the chroma network include reconstructed luma samples (recY), reconstructed chroma samples (recUV), predicted chroma samples (predUV), boundary strength (bsUV), and QP. Regarding network backbone, chroma components use the same one as luma.

### 2.3.2.3. Temporal Filter

FIG. 11 illustrates an example temporal in-loop filter. Only the head part is illustrated. Other parts remain the same as in FIG. 10B-C. {Col 0, Col 1} refers to collocated samples from the first picture in both reference picture lists. Filter set 1 contains an additional in-loop filter, namely temporal fitter, which takes collocated blocks from the first picture in both reference picture lists to improve performance. The two collocated blocks are directly concatenated and fed into the network as shown in FIG. 11. When enabling temporal filtering feature, the temporal filter is applied to the luma component of pictures in three highest temporal layers, while the regular luma and chroma filters are used for other cases. By default, this temporal filtering feature is disabled.

### 2.3.2.4. Adaptive Inference Granularity

The granularity of the filter determination and the parameter selection is dependent on resolution and QP. Given a higher resolution and a larger QP, the determination and selection are performed in a larger region.

### 2.3.2.5. Parameter Selection

Each slice or block, a determination can be made whether to apply the CNN-based filter or not. When the CNN-based filter is determined to be applied to a slice/block, which conditional parameter from a candidate list including three candidates derived from QP could be further decided. The sequence level QP is denoted as q, and the candidate list includes conditional parameters {Param_1, Param_2, Param_3}. For low temporal layers, Param_1=q. Param_2=q−5, Param_3=q−10). For high temporal layers. Param_1=q. Param_2=q−5, Param_3=q+5. In other words, the third candidate is different across different temporal layers.

FIG. 12A illustrates an example parameter selection at an encoder side. FIG. 12B illustrates an example parameter selection at a decoder side. The selection process is based on the rate-distortion cost at the encoder side. Indication of on/off control as well as the conditional parameter index, if needed, are signalled in the bitstream. FIGS. 12A-12B show the diagram of parameter selection at encoder and decoder sides. All blocks in the current frame need to be processed with three conditional parameters first. Then five costs, i.e. Cost_0 . . . , Cost_5, are calculated and compared against each other to achieve optimum rate-distortion performance. In Cost_0, CNN-based filter is prohibited for all blocks. In Cost_i, {i=1, 2, 3}, the parameter Param_i is used for all blocks. In Cost_4, different blocks may prefer different parameters, and the information regarding whether to use CNN-based filter or which parameter to be used is signaled for each block. At decoder side, whether to use CNN-based filter or which parameter to be used for a block is based on the Param_Id parsed from the bit-stream as shown in FIG. 12B.

For all-intra configuration, parameter selection is disabled while filter on/off control is still preserved. A shared conditional parameter is used for the two chroma components to case the burden in worst case at decoder side. In addition, the max number of conditional parameter candidates could be specified at encoder side.

### 2.3.2.6. Residue Scaling

When a NN filter is being applied to reconstructed pictures, a scaling factor is derived and signaled for each color component in the slice header. The derivation is based on least square method. The difference between the input samples and the NN filtered samples (residues) are scaled by the scaling factors before being added to input samples.

2.3.2.7. Combination with Deblocking Filter

To enable a combination with deblocking, the input samples used in the residual scaling is the output of deblocking filtering. The residual scaling process is shown below, where R_{NN} and R_{DB} refer to the outputs of NN filtering and deblocking filtering respectively.

$${R}_{Refine} = ( {R}_{NN} - {R}_{DB} ) \times W + {R}_{DB} = W \times {R}_{NN} + ( 1 - w ) \times {R}_{DB}$$

### 2.3.2.8. Encoder-Only Optimization

Different from NNVC-2.0, EncDbOpt is also enabled for AI configuration. For a better estimation of rate-distortion (RD) cost in the case the NN filter is used, an example encoder introduces NN-based filtering into the rate-distortion optimization (RDO) process of partitioning mode selection. Specifically, a refined distortion is calculated by comparing the NN filtered samples and the original samples. The partitioning mode with the smallest rate-refined distortion cost is selected as the optimal one. To reduce complexity, several fast algorithms are applied. First, NN model is simplified by using a smaller number of residual blocks. Second, parameter selection is not allowed for the NN filtering in the RDO process. Third, the disclosed technique is only applied to the coding units with height and width no larger than 64. The NN filter used in the RDO process is also implemented with SADL using fixed point-based calculation. This NN-based encoder-only method is disabled by default.

### 2.3.2.9. Inference Details

SADL is used for performing the inference of the CNN filters. Both floating point-based and fixed point-based implementations are supported. In the fixed-point implementation, both weights and feature maps are represented with int16 precision using a static quantization method. The network information in the inference stage is provided in Table 3.

TABLE 3
Network Information of filter set 1 in Inference Stage
Network Information in Inference Stage

| Mandatory | HW environment: | |
|---|---|---|
| | GPU Type | N/A |
| | Framework: | SADL |
| | Number of GPUs per Task | 0 |
| | Total Parameter Number | 1.55M/model, 2 models in total for all |
| | | tests |
| | Parameter Precision (Bits) | float: 32 |
| | | int: 16 |
| | Memory Parameter (MB) | float: 6.2MB/model, 2 models |
| | | int: 3.1MB/model, 2 models |
| | Multiply Accumulate (kMAC/pixel) | 532 (assuming frame-level input) |
| | | 673 (assuming block-level input) |
| Optional | Total Conv. Layers | 25 |
| | Total FC Layers | 0 |
| | Total Memory (MB) | |
| | Batch size: | 1 |
| | Patch size | 144 × 144, 272 × 272 |
| | Changes to network configuration or weights | |
| | required to generate rate points | |
| | Peak Memory Usage | |
| | Other information: | |

### 2.3.3. Neural Network-Based Intra Prediction

### 2.3.3.1. Neural Network Inference

FIG. 13 illustrates prediction of a current w×h block Y from the context X of reference samples around Y via the neural network-based intra prediction mode. Here, w=8 and h=4. The neural network-based intra prediction mode contains 7 neural networks, each predicting blocks of a different size in {4×4,8×4, 16×4,32×4,8×8,16×8, 16×16}. The neural network predicting blocks of size w×h is denoted f_{h,w}(·, θ_{h,w}) where θ_{h,w} gathers its parameters. For a given w×h block Y, f_{h,w}(·, θ_{h,w}) takes a preprocessed version \tilde{X} of the context X made of nₐ rows of nₗ+2w+e_{w} reference samples located above this block and nₗ columns of 2h+eₕ reference samples on its left side to provide \tilde{Y}. The application of a postprocessing to \tilde{Y} yields a prediction Ŷ of Y, see FIG. 13. Besides, f_{h,w}(·, θ_{h,w}) returns two indices grpIdx₁ and grpIdx₂. grpIdxᵢ denotes the index characterizing the LFNST kernel index and whether the primary transform coefficients resulting from the application of the DCT-2 horizontally and the DCT-2 vertically to the residue of the neural network prediction are transposed when Ifnstldx=i, i∈{1, 2}, see FIG. 13. Furthermore, f_{h,w}(·, θ_{h,w}) gives the index repIdx ∈ [symbol] 0,66 [symbol] of the VVC intra prediction mode (PLANAR or DC or directional intra prediction mode) whose prediction of Y from the reference samples surrounding Y best represents Ŷ, see FIG. 13.

```
If min(h, w) ≤ 8 && hw < 256:
  nₐ = nₗ = min(h, w)
otherwise:
  if h > 8:
      nₐ = h/2
  otherwise:
    nₐ = h
  if w > 8:
    nₗ = w/2
  otherwise:
    nₗ = w
If h ≤ 8, eₕ = 4. Otherwise, eₕ = 0.
If w ≤ 8, e_{w} = 4. Otherwise, e_{w} = 0.
```

### 2.3.3.2. Preprocessing and Postprocessing

### 2.3.3.2.1. Preprocessing of the Context of the Current Block

The preprocessing shown in FIG. 13 comprises the four following steps.
The mean μ of the available reference samples X̅ in X, see FIG. 3, is subtracted from X.
If the neural network predicting the current block is in floats, the reference samples in the context X are multiplied by ρ=1/(2^{b-8}), b being the internal bitdepth, i.e. 10 in VVC. Otherwise, the reference samples in the context X are multiplied by ρ=2^{Q}^{ᵢₙ}^{-b+8}, Qᵢₙ denoting the input quantizer.
All the unavailable reference samples Xᵤ in X, see FIG. 3, are set to 0.
The context resulting from the previous step is flattened, yielding X, a vector of size

$${n}_{a} ( {n}_{l} + 2 w + {e}_{w} ) + ( 2 h + {e}_{h} ) {n}_{l} .$$

FIG. 14 illustrates decomposition of a context X of reference samples surrounding the current w×h block Y into the available reference samples X and the unavailable reference samples Xᵤ. Here, w=8 and h=4. In the illustrated case, the number of unavailable reference samples reaches its maximum value.

### 2.3.3.2.2. Postprocessing of the Neural Network Prediction

The postprocessing depicted in FIG. 13 comprises reshaping the vector \tilde{Y} of size hw into a rectangle of height h and width w, dividing the result of the reshape by ρ, adding the mean u of the available reference samples in the context of the current block, and clipping to [0,2^{b}−1]. Therefore, the postprocessing can be summarized as:

$$\hat{Y} = min ( max ( \frac{reshape ( \tilde{Y} )}{ρ} + μ , 0 ) , {2}^{b} - 1 ) .$$

### 2.3.3.3. Adaptation of the Derivation of the List of MPMs

When creating the MPM list of a given luma CB, if the “left” luma CB is predicted via the neural network-based intra prediction mode, the neural network-based mode index can be replaced by the repIdx returned during the prediction of the “left” luma CB and become a candidate index to be put into the MPM list. Similarly, if “above” luma CB is predicted via the neural network-based intra prediction mode, the neural network-based mode index can be replaced by the repIdx returned during the prediction of the “above” luma CB and become a candidate index to be inserted into the MPM list.

### 2.3.3.4. Signaling of the Neural Network-Based Intra Prediction Mode

### 2.3.3.4.1. Signaling of the Neural Network-Based Intra Prediction Mode in Luma

FIG. 15 illustrates intra prediction mode signaling for the current w×h luma CB framed in the dashed line. The coordinates of the pixel at the top-left of this CB are (y, x). The bin value of a nnFlag value appears in bold black. Here, h=8, w=4, x=8, and y=0.

For the current w x h luma CB whose top-left pixel is at position (y, x) in the current luma channel, the intra prediction mode signaling in luma is split into two cases.
If (h, w)∈T, nnFlag appears in the intra prediction mode signaling in luma. nnFlag=1 means that the neural network-based intra prediction mode is selected to predict the current luma CB and END. nnFlag=0 means that the neural network-based intra prediction mode is not selected to predict the current luma CB, then the regular intra prediction mode signaling in luma, denoted Sc, applies, see FIG. 15.
Otherwise, the regular intra prediction mode signaling in luma S_{⊂} applies.

Note that, in the case “(h, w)∈T && nnFlag=1”, if the context of the current luma CB goes out of the bounds of the current luma channel, i.e. x<nₗ∥y<nₐ, the neural network-based intra prediction is replaced by PLANAR.

T = {(4,4), (4,8), (8,4), (4,16), (16,4), (4,32), (32,4), (8,8), (8,16), (16,8), (8,32), (32,8),
(16,16), (16,32), (32,16), (32,32), (64,64)}.

### 2.3.3.4.2. Signaling of the Neural Network-Based Intra Prediction Mode in Chroma

For the current w×h chroma CB whose top-left pixel is at position (y, x) in the current chroma channel, the intra prediction mode signaling in chroma is split into two cases.
If the luma CB collocated with this chroma CB is predicted by the neural network-based intra prediction mode:
   If (h, w)∈T, the DM becomes the neural network-based intra prediction mode.
   Otherwise, the DM is set to PLANAR.
Otherwise:
   If (h,w)∈T, nnFlagChroma appears in the intra prediction mode signaling in chroma. nnFlagChroma is placed before the DM flag in the decision tree of the intra prediction mode signaling in chroma. nnFlagChroma=1 means that the neural network-based intra prediction mode is selected to predict the current pair of chroma CBs and END. nnFlagChroma=0 means that the neural network-based intra prediction mode is not selected to predict the current pair of chroma CBs, then the regular intra prediction mode signaling in chroma resumes from the DM flag.
   Otherwise, the regular intra prediction mode signaling in chroma applies.

Note that, in the case where “(h, w)∈T and the DM becomes the neural network-based intra prediction mode” and the case where “(h, w)∈T && nnFlagChroma=1”, if the context of the current chroma CB goes out of the bounds of the current chroma channel, i.e. x<nₗ∥y<nₐ, the neural network-based intra prediction is replaced by PLANAR.

### 2.3.3.5. Transformation of the Context and the Neural Network Prediction

For a given w×h block, if (h, w)∈T, it is possible that the neural network-based intra prediction mode must predict this block but the neural network-based intra prediction mode does not contain f_{h,w}(·, θ_{h,w}). In this case, the context of the current block can be down-sampled vertically by a factor δ and/or down-sampled horizontally by a factor γ and/or transposed before the step called “preprocessing” in FIG. 13. Then, the prediction of the current block can be transposed and/or up-sampled vertically by the factor δ and/or up-sampled horizontally by the factor γ after the step called “postprocessing” in FIG. 13. The transposition of the context of the current block and the prediction, δ, and γ are chosen so that a neural network belonging to the neural network-based intra prediction mode is used for prediction, see Table 4.

TABLE 4
decision of transposing the context of the current w × h block
to be predicted and the prediction of this block, the value of γ, and
the value of δ, and the neural network belonging to the neural network-
based intra prediction mode used for prediction for each (h, w) ∈ T.

| height and width | | | | |
|---|---|---|---|---|
| of the block to | | | | neural network used |
| be predicted (h, w) | γ | δ | transposition | for prediction |
| (4, 4) | 1 | 1 | no | f_{4, 4}(., θ_{4, 4}) |
| (4, 8) | 1 | 1 | no | f_{4, 8}(., θ_{4, 8}) |
| (8, 4) | 1 | 1 | yes | f_{4, 8}(., θ_{4, 8}) |
| (4, 16) | 1 | 1 | no | f_{4, 16}(., θ_{4, 16}) |
| (16, 4) | 1 | 1 | yes | f_{4, 16}(., θ_{4, 16}) |
| (4, 32) | 1 | 1 | no | f_{4, 32}(., θ_{4, 32}) |
| (32, 4) | 1 | 1 | yes | f_{4, 32}(., θ_{4, 32}) |
| (8, 8) | 1 | 1 | no | f_{8, 8}(., θ_{8, 8}) |
| (8, 16) | 1 | 1 | no | f_{8, 16}(., θ_{8, 16}) |
| (16, 8) | 1 | 1 | yes | f_{8, 16}(., θ_{8, 16}) |
| (8, 32) | 2 | 1 | no | f_{8, 16}(., θ_{8, 16}) |
| (32, 8) | 1 | 2 | yes | f_{8, 16}(., θ_{8, 16}) |
| (16, 16) | 1 | 1 | no | f_{16, 16}(., θ_{16, 16}) |
| (16, 32) | 2 | 1 | no | f_{16, 16}(., θ_{16, 16}) |
| (32, 16) | 1 | 2 | no | f_{16, 16}(., θ_{16, 16}) |
| (32, 32) | 2 | 2 | no | f_{16, 16}(., θ_{16, 16}) |
| (64, 64) | 4 | 4 | no | f_{16, 16}(., θ_{16, 16}) |

### 2.3.4. Small Ad-Hoc Deep Learning (SADL) Library

SADL (Small Ad-hoc Deep-Learning Library) is a header only small library for inference of neural networks. SADL provides both floating-point-based and integer-based inference capabilities. The inference of neural networks in NNVC is based on the SADL.

The table below summarizes the framework characteristics.

TABLE 5
Characteristics of SADL

| | |
|---|---|
| Language | Pure C++, header only. |
| Footprint | ~6000 LOC, library ~300 kB, no dependency |
| Optimization | Some SIMD at hot spots, e.g. convolution |
| | (conv2D) and automatic sparse matrix- |
| | vector multiplication |
| Compatibility | Onnx to SADL converter |
| Layer Supports | constants, add, maxPool, matMul (dense and |
| | sparse), reshape, ReLU, conv2D (strided, |
| | grouped, separated), mul, concat, max, |
| | leakyReLU, shape, expand, PReLU, flatten, |
| | transpose, Cond2DTranspose, Slicing |
| Type support | float, int32, int16, int8 |
| Quantization | Support adaptive quantizer per layer |
| License | BSD 3-Clause |

NNVC repository uses SADL as a submodule.

### 3. Technical Problems Solved by Disclosed Technical Solutions

According to the disclosure, an example NN-based loop filtering has the following problems:

First, the same convolutions are used for each input of NN-based loop filter. However, different inputs may have different importance. Therefore, it is reasonable to assign different convolutions with different kernel size and channel numbers for each input.

Second, the convolution with kernel size K×K is widely used in NN-based loop filter. However, it can be decomposed into combinations of several convolutions with smaller kernel size to reduce the complexity.

Third, side information generated during compression may be used as extra input to improve the performance of NN-based loop filter. For example, prediction picture, slice type, boundary strength, base QP, slice QP, and IPB information could be used as side information.

Fourth, multi-scale structure for neural network may be beneficial for improving the performance of NN-based loop filter.

Fifth, the NN-based network is used for designing loop filter. However, non-adjacent information is not considered. The Transformer based network could capture global information.

Sixth, the NN-based filter is proposed to enhance reconstruction. However, the example filter may exceed the NN-based filter for some video content. So it is reasonable to combine the standardized filter and NN filter.

Seventh, the parameters of NN-based filter are fixed in the training process. However, the parameter such as QP, inference size, block extension size should adapt to the various video content in the inference process.

Eighth, the NN-based loop filter may be used for luma component, chroma component, or both luma and chroma components.

Ninth, the NN-based loop filter may be used for intra slice, inter slice, or both intra and inter slices.

### 4. A Listing of Solutions and Embodiments

The detailed embodiments below should be considered as examples to explain general concepts. These examples should not be interpreted in a narrow way. Furthermore, these embodiments can be combined in any manner.

One or more neural network (NN) filter models are trained as part of an in-loop filtering technology or filtering technology used in a post-processing stage for reducing the distortion incurred during compression. Samples with different characteristics are processed by different NN filter models. This disclosure elaborates how to design a unified NN filter model by feeding at least one indicator which may be related to the quality level (e.g. QP or Constant rate factor (CRF) value or bitrates)/slice type/coding modes/coded information as the input of NN filter.

It should be noted that the concept of unifying NN model by feeding the indicator as the input of NN process could be also extended to other NN-based coding tools, such as NN-based intra prediction, NN-based cross component prediction, NN-based inter prediction, NN-based super-resolution, NN-based motion compensation, NN-based transform design. In the examples below, NN-based filtering technology is used as an example.

It should also be noted that the concept of feeding the coded information as the input of NN process could be also extended to non-NN-based coding tools, such as non-NN-based intra prediction, non-NN-based cross component prediction, non-NN-based inter prediction, non-NN-based super-resolution, non-NN-based motion compensation, non-NN-based transform design. For example, a non-NN based coding tool may classify the to-be-filtered samples into different categories using the coded information.

In the disclosure, a NN filter can be any kind of NN filter, such as a convolutional neural network (CNN) filter, fully connected neural network filter, transformer-based filter, recurrent neural network-based filter.

In the following discussion, a video unit may be a sequence, a picture, a slice, a tile, a brick, a subpicture, a CTU/CTB, a CTU/CTB row, one or multiple CUs/CBs, one ore multiple CTUs/CTBs, one or multiple VPDU (Virtual Pipeline Data Unit), a sub-region within a picture/slice/tile/brick. A father video unit represents a unit larger than the video unit. Typically, a father unit will contain several video units. E.g., when the video unit is CTU, the father unit could be slice, CTU row, multiple CTUs, etc.

### To Simplify the NN Filter by Adaptive Channel Number

1. To solve problem 1, different convolution types are assigned to different inputs.
   a. In one example, the convolution shares the same convolution kernel size and different channel numbers may be assigned for each input.
      i. In one example, the channel numbers for each input are denoted as C₁, C₂, . . . , Cₙ where n is an integer which denotes the number of inputs.
         1) In one example, furthermore, one constraint is added that for any indexes i and j where 1≤i, j≤n that Cᵢ≠Cⱼ.
         2) In one example, furthermore, one constraint is added that there is at least one pair of indexs i and j where 1≤i, j≤n that Cᵢ≠Cⱼ.
   b. In one example, the convolution shares the same convolution channel numbers and different convolution kernel size are assigned for each input.
      i. In one example, 1×1 kernel size may be used for the convolution of partial input and K×K kernel size is used for the convolution of the rest input. The K denotes an integer value greater than 1.
   c. In one example, different convolution channel numbers and different convolution kernel size are assigned for each input.

### To Simplify the NN Filter by Decomposition

2. To solve problem 2, the C₁×C₂×K×K convolution may be decomposed into a combination of several convolutions with smaller kernel size. The K denotes an integer value greater than 1, C₁ and C₂ denote the input channel number and output channel number of the convolution, respectively.
   a. In one example, the input and output channel number of the convolution may be not changed when it is decomposed.
      i. In one example, the C₁×C₂×K×K convolution is decomposed into a combination of C₁×C₂×1×K convolution followed by C₁×C₂×K×1 convolution.
      ii. In one example, the C₁×C₂×K×K convolution is decomposed into a combination of C₁×C₂×1×K convolution followed by C₁×C₂×K×1 convolution and any activation layer may be placed after each convolution.
      iii. In one example, the C₁×C₂×K×K convolution is decomposed into a combination of C₁×C₂×K×1 convolution followed by C₁×C₂×1×K convolution.
      iv. In one example, the C₁×C₂×K×K convolution is decomposed into a combination of C₁×C₂×K×1 convolution followed by C₁×C₂×1×K convolution and any activation layer may be placed after each convolution.
   b. In one example, the input and output channel number of the convolution may be changed when it is decomposed.
      i. In one example, the C₁×C₂×K×K convolution is decomposed into a combination of C₁×C₃×1×K convolution followed by C₃×C₂×K×1 convolution, where C₃ is a postive integer different with C₂.
      ii. In one example, the C₁×C₂×K×K convolution is decomposed into a combination of C₁×C₃×1×K convolution followed by C₃×C₂×K×1 convolution and any activation layer may be placed after each convolution, where C₃ is a postive integer different with C₂.
      iii. In one example, the C₁×C₂×K×K convolution is decomposed into a combination of C₁×C₃×K×1 convolution followed by C₃×C₂×1×K convolution, where C₃ is a postive integer different with C₂.
      iv. In one example, the C₁×C₂×K×K convolution is decomposed into a combination of C₁×C₃×K×1 convolution followed by C₃×C₂×1×K convolution and any activation layer may be placed after each convolution, where C₃ is a postive integer different with C₂.
   c. In one example, partial K×K convolutions are decomposed.
   d. In one example, all the K×K convolutions are decomposed.

### To Design Side Information of NN Filter

3. To solve problem 3, which side information to be used as extra input of NN-based loop filter and how they are processed is specified.
   a. In one example, the side information may be used as extra input of NN-based loop filter.
      i. In one example, the slice QP may be used as extra input of NN-based loop filter.
         1) In one example, furthermore, the slice QP is normalized by sliceQP÷MAX_QP where the value of MAX_QP may be 63.
         2) In one example, furthermore, the slice QP is first tiled or spanned into a 2-dimensional arrays with the same size as the video unit to be filtered.
      ii. In one example, the base QP may be used as extra input of NN-based loop filter.
         1) In one example, furthermore, the base QP is normalized by baseQP=MAX_QP where the value of MAX_QP may be 63.
         2) In one example, furthermore, the base QP is first tiled or spanned into a 2-dimensional arrays with the same size as the video unit to be filtered.
      iii. In one example, the prediction picture may be used as extra input of NN-based loop filter.
      iv. In one example, the slice type may be used as extra input of NN-based loop filter.
         1) In one example, furthermore, the slice type may be a binary value which indicates whether the picture to be filtered is intra slice.
         2) In one example, the slice type indicator is first tiled or spanned into a 2-dimensional arrays with the same size as the video unit to be filtered.
      v. In one example, the IPB information of the video unit to be filtered may be used as extra input of NN-based loop filter.
         1) In one example, furthermore, the IPB information may be derived from the slice type.
         a. In one example, the value of IPB information is derived as follows, it is equal to a if slice type is I slice, or it is equal to b if slice type is B slice, or it is equal to c if slice type is P slice, where a, b, and c are constants.
         i. In one example, b=c.
         ii. In one example, b=−a, c=−a.
         iii. In one example, a=1, b=−1, c=−1.
         iv. In one example, a=1, b=0.5, c=0.5.
         2) In one example, the IPB information is first tiled or spanned into a 2-dimensional arrays with the same size as the video unit to be filtered.
      vi. In one example, the boundary strength of the video unit to be filtered may be used as extra input of NN-based loop filter.
      vii. In one example, any combination of above side information may be used as extra input of NN-based loop filter.
   b. In one example, convolutions for each input side information are performed separately and then all the convolution results are concatenated with the output of convolution of reconstruction picture.
   c. In one example, the reconstruction picture and side information are concatenated and followed by a convolution.
4. To solve problem 4, muti-scale neural network structure may be used in the NN-based loop filter.
   a. In one example, neural network with two branches may be used and one possible solution is presented as follows. FIG. 16 illustrates an example multi-scale neural network with two branches for use in a NN-based loop filter. In FIG. 16, Kᵢ denotes the kernel size where 1≤i≤4, Cⱼ is related to the channel numbers, where 1≤j≤8.
      i. In one example, further more, the convolution with kernel size K×K may be decomposed into several convolutions with smaller kernel size, which is a combination with bullets 2.
      ii. In one example, the activation layers may be used.
         1) In one example, furthermore, the activation layers may be used after the activation layers may be used after all the convolution layers.
         2) In one example, furthermore, the activation layers may be used after the activation layers may be used after partial the convolution layers.
         3) In one example, the activation layers might be PRelu layer.
         4) In one example, the activation layers might be Relu layer.
      iii. In one example, the residual connection may be used.
   b. In one example, neural network with multiple branches may be used. In each branch, different convolution with different kernel size, channel number, or stride might be used.
      i. In one example, further more, the convolution with kernel size K×K may be decomposed into several convolutions with smaller kernel size, which is a combination with bullets 2.
      ii. In one example, the activation layers may be used.
         1) In one example, furthermore, the activation layers may be used after the activation layers may be used after all the convolution layers.
         2) In one example, furthermore, the activation layers may be used after the activation layers may be used after partial the convolution layers.
         3) In one example, the activation layers might be PRelu layer.
         4) In one example, the activation layers might be Relu layer.
      iii. In one example, the residual connection may be used.
   c. In one example, this muti-scale neural network structure may be used as basic block in the whole NN-based loop filter.
      i. In one example, this basic block may be used N times where N is an integer greater than 0.
      ii. In one example, this basic block may be used together with other kinds of blocks.
         1) In one example, this basic block may be used together with other convolution layers and activation layers.
         2) In one example, this basic block may be used together with residual blocks.

### To Design Transformer Based NN Filter

5. To solve problem 5, it is proposed that Transformer-based structure may be involved in the design of the NN filter.
   a. In one example, the head/backbone/tail may be designed by using Transformer network.
6. To solve problem 5, it is proposed that Transformer-based structure may be combined with CNN in the design of the NN filter.
   a. In one example, CNN module may be followed by Transformer module in the network of NN filter.
7. To solve problem 5, it is proposed that transformer-based structure and CNN-based structure may be alternative in the design of the NN filter.
   a. In one example, the NN filters may be selected when there are two NN-based filters which contain one CNN-based filter and one transformer-based filter.
      To Combine NN Filter with DBF/SAO
8. To solve problem 6, it is proposed that the NN filter may be combined/fused/blended with traditional filters.
   a. In one example, traditional filters may be Deblocking filter (DBF).
   b. In one example, traditional filters may be Sample Adaptive Offset (SAO).
   c. In one example, traditional filters may be the combination of DBF and SAO.
   d. In one example, the NN filter and DBF may be fused/blended.
      i. In one example, SAO may be after the fusing/blending of NN filter and DBF filter.
         1) In one example, SAO may be enabled/disabled by the syntax element in the SPS/PPS, etc.
      ii. In one example, ALF may be used after SAO.
         1) In one example, ALF may be enabled/disabled by the syntax element in the SPS/PPS, etc.
   e. In one example, the NN filter and the combination of DBF and SAO may be fused/blended.
      i. In one example, Adaptive Loop Filter (ALF) may be used after the fusing/blending of NN filter and the combination of DBF and SAO.
         1) In one example, ALF may be enabled/disabled by the syntax element in the SPS/PPS, etc.

### To Design Scaling Factor

9. To solve problem 6, it is proposed that the reconstruction samples of traditional filter and NN filter are fused/blended by a scaling factor.
   a. In one example, reconstruction samples may be fused/blended in slice/block level.
   b. In one example, the scaling factor may be adaptive which can be determined by video content.
   c. In one example, the scaling factor may be pre-defined.
   d. In one example, the scaling factor may be separated for different components.
      i. In one example, the scaling factor may be separated for luma and chroma components.
      ii. In one example, the scaling factor may be separated for U and V components.

### To Design QP Adjustment, Parameter Number, Block QP Adaptation

10. To solve problem 7, it is proposed that there is a candidate list which contains multiple input parameters.
   a. In one example, the number of candidates in the list may be configurable in sequence/slice/block level.
   b. In one example, the candidate list may be constructed in sequence/slice/block level.
   c. In one example, the candidate list may be adaptive for sequence/slice/block level.
   d. In one example, the input parameter is a variable dependent on base QP which denoted as q.
      i. In one example, q is QP in sequence/slice/block level.
   e. In one example, the candidate list may include the base QP and adjusted QP.
      i. In one example, adjusted QP may be equal to the base QP q by adding an offset.
      ii. In one example, offset may be equal to −5, 10, 5.
      iii. In one example, offset may be dependent on the TID level.

### To Design Adaptive Inference Granularity/Configurable Inference Size

11. To solve problem 7, t is proposed that the inference granularity/size of NN filter may be adaptive for the sequence/slice/block level.
   a. In one example, the granularity/size may be dependent on the slice type.
   b. In one example, the granularity/size may be configurable which dependent on the syntax element in the sequence/slice/block level.

### To Design Block Extension Size

12. To solve problem 7, it is proposed that the block extension/padding size may be adaptive for the sequence/slice/block level.
   a. In one example, the block extension/padding size may be dependent on the block modes and/or slice type.
   b. In one example, the block extension/padding size may be configurable which dependent on the syntax element in the sequence/slice/block level.

### To the Usage of Unified NN Filter

13. To solve problem 8, the output of NN-based filter may be luma components, chroma components, or both luma and chroma components.
   a. In one example, separate NN-based filters may be used for generating outputs of luma components and outputs of chroma components, respectively.
      i. In one example, furthermore, a total number of M₁ models may be used for generating output of luma components, and a total number of M₂ models may be used for generating outputs of chroma components, where both M₁ and M₂ are integers greater than 0.
         1) In one example, furthermore, the Cb and Cr components may share the same chroma model of NN-based filter.
   b. In one example, a single NN-based filters may be used for generating outputs of luma components and outputs of chroma components.
      i. In one example, furthermore, a total number of M₁ models may be used, and for each model, the outputs of luma components and chroma components may be generated, where M₁ is an integer greater than 0.
      ii. In one example, furthermore, the output luma and chroma components generated by the single NN-based filter may be used together.
      iii. In one example, furthermore, the output luma and chroma components generated by the single NN-based filter may be used seperately.
         1) In one example, furthermore, the output luma component generated by the single NN-based filter may be used and the output luma component generated by the single NN-based filter may be NOT used.
         2) In one example, furthermore, the output luma component generated by the single NN-based filter may be NOT used and the output luma component generated by the single NN-based filter may be used.
14. To solve problem 8, the single NN-based filter may generate the outputs of both luma and chroma components.
   a. In one example, one or more syntax elements may be signaled to control the usage of NN-based filter in the slice level.
      i. In one example, one or more syntax elements may indicate whether to use the NN-based fitler for the slice level.
      ii. In one example, one or more syntax elements may indicate which NN-based fitler is used.
      iii. In one example, the syntax elements may indicate the usage of NN-based filter separately for Y, U, and V components for slice level.
         1) In one example, the syntax elements indicating the usage of NN-based filter separately for Y, U, and V components may be dependent on the syntax element which indicating whether to use the NN-based filter for slice level.
      iv. In one example, one or more syntax elements may indicate whether NN-based fitlers can be adaptively selected in the CTU/CTB level.
   b. In one example, one or more syntax elements may be signaled to control the usage of NN-based filter in the CTU/CTB level.
      i. In one example, one or more syntax elements may indicate whether to use the NN-based filter for CTU/CTB level.
      ii. In one example, one or more syntax elements may indicate which NN-based filter is used for CTU/CTB level.
         1) In one example, the syntax elements indicating which NN-based filter is used may be dependent on the syntax element indicating whether to use the NN-based filter for CTU/CTB level.
      iii. In one example, the syntax elements may indicate the usage of NN-based filter separately for Y, U, and V components for CTU/CTB level.
         1) In one example, the syntax elements indicating the usage of NN-based filter separately for Y, U, and V components may be dependent on the syntax element which indicating whether to use the NN-based filter for CTU/CTB level.
         a. In one example, the syntax elements which indicating the usage of NN-based filter separately for Y, U, and V components may be signaled when the syntax element which indicating whether to use the NN-based filter for CTU/CTB level has been parsed and NN-based filter is used for CTU/CTB level.
         b. In one example, the syntax elements which indicating the usage of NN-based filter separately for luma and chroma components may be NOT signaled when the syntax element which indicating whether to use the NN-based filter for CTU/CTB level has been parsed and NN-based filter is NOT used for CTU/CTB level.
         2) In one example, the syntax elements indicating the usage of NN-based filter for V component may be dependent on the syntax elements indicating the usage of NN-based filter for Y, and U components.
         a. In one example, the syntax elements indicating the usage of NN-based filter for V component may be NOT signalled and inferred to use NN-based filter for V component when the syntax elements indicating the usage of NN-based filter for Y, and U components have been parsed and NN-based filter is NOT used for Y, and U component.
         b. In one example, the syntax elements indicating the usage of NN-based filter for V component may be signalled when the syntax elements indicating the usage of NN-based filter for Y, and U component has been parsed and NN-based filter is used for Y, and/or U component.
      iv. In one example, the syntax elements may indicate the usage of NN-based filter separately for luma and chroma components for CTU/CTB level.
         1) In one example, the syntax elements indicating the usage of NN-based filter separately for luma and chroma components may be dependent on the syntax element which indicating whether to use the NN-based filter for CTU/CTB level.
         a. In one example, the syntax elements which indicating the usage of NN-based filter separately for luma and chroma components may be signaled when the syntax element which indicating whether to use the NN-based filter for CTU/CTB level has been parsed and NN-based filter is used for CTU/CTB level.
         b. In one example, the syntax elements which indicating the usage of NN-based filter separately for luma and chroma components may be NOT signaled when the syntax element which indicating whether to use the NN-based filter for CTU/CTB level has been parsed and NN-based filter is NOT used for CTU/CTB level.
         2) In one example, the syntax elements indicating the usage of NN-based filter for chroma component may be dependent on the syntax elements indicating the usage of NN-based filter for luma component.
         a. In one example, the syntax elements indicating the usage of NN-based filter for chroma component may be NOT signalled and inferred to use NN-based filter for chroma component when the syntax elements indicating the usage of NN-based filter for luma component has been parsed and NN-based filter is NOT used for luma component.
         b. In one example, the syntax elements indicating the usage of NN-based filter for chroma component may be signalled when the syntax elements indicating the usage of NN-based filter for luma component has been parsed and NN-based filter is used for luma component.
         3) In one example, the syntax elements may indicate the usage of NN-based filter separately for U, and V components in CTU/CTB level.
         a. In one example, the syntax elements indicating the usage of NN-based filter separately for U, and V components may be dependent on the syntax element which indicating whether to use the NN-based filter for chroma component in CTU/CTB level.
         i. In one example, the syntax elements which indicating the usage of NN-based filter separately for U, and V components may be signaled when the syntax element which indicating whether to use the NN-based filter for chroma component in CTU/CTB level has been parsed and NN-based filter is used for chroma component in CTU/CTB level.
         ii. In one example, the syntax elements which indicating the usage of NN-based filter separately for U, and V components may be NOT signaled when the syntax element which indicating whether to use the NN-based filter for chroma component in CTU/CTB level has been parsed and NN-based filter is NOT used for chroma component in CTU/CTB level.
         ′b. In one example, the syntax elements indicating the usage of NN-based filter for V component may be dependent on the syntax elements indicating the usage of NN-based filter for U components.
         i. In one example, the syntax elements indicating the usage of NN-based filter for V component may be NOT signalled and inferred to use NN-based filter for V component when the syntax elements indicating the usage of NN-based filter for U components have been parsed and NN-based filter is NOT used for U component.
         ii. In one example, the syntax elements indicating the usage of NN-based filter for V component may be signalled when the syntax elements indicating the usage of NN-based filter for U component has been parsed and NN-based filter is used for U component.
      v. In one example, whether to signal the syntax elements in CTU/CTB level may be dependent on the syntax elements signaled in the slice level.
15. To solve problem 9, a single NN-based filters may be used for generating filtered outputs for both intra and inter slices.
   a. In one example, intra slice may refer to I slice.
      i. In one example, inter slice may refer to B slice or P slice or B and P slices.

### To Design Unified NN Filter

16. It is proposed that a unified NN filter is designed by the all or part of mentioned items which should not be interpreted in a narrow way.

### 5. Embodiments

### 5.1 Embodiment 1

FIG. 17 illustrates an example network structure of NN filter. The Network structure of NN filter in FIG. 17 includes Item 3 side information and Item 4 multi-scale NN structure.

### 5.2 Embodiment 2

FIG. 18 illustrates an example network structure of NN filter. The Network structure of NN filter in FIG. 18 includes Item 1 adaptive channel number, Item 3 side information, and Item 4 muti-scale NN structure. The Cony A, Conv B, . . . , Cony G are convolutions with different channel numbers. The larger text font means larger channel numbers, for example, the Cony A is convolution with the largest channel number.

### 5.3 Embodiment 3

FIG. 19 illustrates an example network structure of NN filter. The Network structure of NN filter in FIG. 19 includes Item 2 decomposition, Item 3 side information, and Item 4 multi-scale NN structure.

### 5.4 Embodiment 4

FIG. 20 illustrates an example network structure of NN filter. The Network structure of NN filter in FIG. 20 includes Item 1 adaptive channel number, Item 2 decomposition, Item 3 side information, and Item 4 muti-scale NN structure. The Cony A, Conv B, . . . , Cony G are convolutions with different channel numbers. The larger text font means larger channel numbers, for example, the Cony A is convolution with the largest channel number.

### 5.5 Embodiment 5

FIG. 21 illustrates an example network structure of NN filter. The Network structure of NN filter of FIG. 21 includes Item 1 adaptive channel number, Item 2 decomposition, Item 3 side information, Item 4 multi-scale NN structure, and Item 5 Transformer.

### 5.6 Embodiment 6

FIG. 22 illustrates an example network structure of NN filter. The Network structure of NN filter in FIG. 22 includes Item 1 adaptive channel number, Item 2 decomposition, Item 3 side information, Item 4 muti-scale NN structure, and Item 5 Transformer. The Conv A, Conv B, . . . , Cony G are convolutions with different channel numbers. The larger text font means larger channel numbers, for example, the Cony A is convolution with the largest channel number.

### 5.7 Embodiment 7

Separate models are used for generating luma and chroma components, respectively. FIGS. 23A-23C illustrates an example structure and examples parameters of a luma model in accordance with some embodiments of the present disclosure. The FIGS. 23A-23C show the structure and the number in the table shows the hyper-parameters of each convolution layer.

FIGS. 24A-24C illustrates an example structure and examples parameters of a chroma model in accordance with some embodiments of the present disclosure. FIGS. 24A-24C show the structure and the number in the table shows the hyper-parameters of each convolution layer.

### 5.8 Embodiment 8

One single model is used for generating the output of luma and chroma components together. FIGS. 25A-25C illustrates an example structure and examples parameters of a single model for processing luma and chroma components in accordance with some embodiments of the present disclosure. FIGS. 25A-25C show the structure and the number in the table shows the hyper-parameters of each convolution layer.

More details of the embodiments of the present disclosure will be described below which are related to neural network-based in-loop filtering for neural network-based video coding. As used herein, the term “video unit” may represent a block. a subblock, a coding tree block (CTB), a coding tree unit (CTU), a coding block (CB), a coding unit (CU), a prediction unit (PU), a transform unit (TU), a prediction block (PB), a transform block (TB), a tile, a slice, a subpicture, a video processing unit comprising multiple samples/pixels, and/or the like. A video unit may be rectangular or non-rectangular. In addition, the term “neural network based (NN-based) filter” and “neural-network (NN) filter” may be used interchangeably. The embodiments of the present disclosure should be considered as examples to explain the general concepts and should not be interpreted in a narrow way. Furthermore, these embodiments can be applied individually or combined in any manner.

FIG. 26 illustrates a flowchart of a method 2600 for video processing in accordance with some embodiments of the present disclosure. As shown in FIG. 26, at 2602, a conversion between a current video unit of a video and a bitstream of the video is performed. In some embodiments, the conversion may include encoding the current video unit into the bitstream. Alternatively or additionally, the conversion may include decoding the current video unit from the bitstream.

The bitstream comprises at least one indication indicating first information regarding a usage of an NN-based filter for the current video unit. The NN-based filter is configured to process a luma component and a chroma component of the current video unit. In other words, the NN-based filter is capable of processing both luma and chroma components.

In some embodiments, the first information may comprise whether to use the NN-based filter for the current video unit. Additionally or alternatively, the first information may comprise at least one parameter for the NN-based filter that is used for the current video unit. For example, the at least one parameter may comprise a quantization parameter (QP) or the like. In some additional or alternative embodiments, the first information may comprise whether information regarding the usage of the NN-based filter is determined at a first level lower than a level of the current video unit. By way of example rather than limitation, the current video unit may be a slice, and thus the first level may be a level lower than the slice level, such as a coding tree unit (CTU) level, a coding tree block (CTB) level, or the like.

In some embodiments, the at least one indication may comprise a single indication. As used herein, an indication may be implemented as a syntax element, an index, a flag, or the like. By way of example, the value range of the single indication may be from 0 to 4. The value of the single indication being equal to 0 may indicate that the NN-based filter is not used for the current video unit. The value of the single indication being equal to 1 may indicate that the NN-based filter is used for the current video unit and a base QP is used for the NN-based filter. The value of the single indication being equal to 2 may indicate that the NN-based filter is used for the current video unit and a base QP plus an offset is used for the NN-based filter. The value of the single indication being equal to 3 may indicate that the NN-based filter is used for the current video unit and a base QP minus an offset is used for the NN-based filter. The value of the single indication being equal to 4 may indicate that information regarding the usage of the NN-based filter is determined at the first level lower than the level of the current video unit.

It should be understood that the above examples are described merely for purpose of description. The scope of the present disclosure is not limited in this respect. For example, the at least one indication may also comprise more than one indication.

In some alternative or additional embodiments, the first information may comprise at least one of the following: which NN-based filter may be used for the current video unit, whether to use the NN-based filter for a Y component of the current video unit, whether to use the NN-based filter for a U component of the current video unit, or whether to use the NN-based filter for a V component of the current video unit. Furthermore, whether the bitstream comprises one or more indications indicating at least one of the following may be dependent on an indication indicating whether to use the NN-based filter for the current video unit: whether to use the NN-based filter for a Y component of the current video unit, whether to use the NN-based filter for a U component of the current video unit, or whether to use the NN-based filter for a V component of the current video unit.

In view of the above, the NN-based filter is capable of processing both luma and chroma components and information regarding the usage of this NN-based filter is signaled. Compared with the conventional solution, the proposed method can advantageously enable flexible usage of the NN-based filter. Thereby, the coding efficiency can be improved.

In some further embodiments, the current video unit may comprise a plurality of video blocks at the first level lower than the level of the current video unit. In addition, one or more indications indicate second information regarding a usage of the NN-based filter for a first video block of the plurality of video blocks. In one example embodiment, the first level may be a CTU level, and the first video block may comprise a CTU. In another example embodiment, the first level may be a CTB level, and the video block may comprise a CTB.

In some embodiments, the second information may comprise whether to use the NN-based filter for the first video block. Additionally or alternatively, the second information may comprise one or more parameters for the NN-based filter that are used for the first video block. For example, the one or more parameters may comprise a quantization parameter (QP) or the like.

By way of example, the one or more indications may comprise a first indication indicating whether to use the NN-based filter for the first video block, and a second indication indicating the one or more parameters. By way of example, the value range of the first indication may be from 0 to 1, and the value range of the first indication may be from 0 to 2. The value of the first indication being equal to 0 may indicate that the NN-based filter is not used for the first video block. The value of the first indication being equal to 1 may indicate that the NN-based filter is used for the first video block. The value of the second indication being equal to 0 may indicate that a base QP is used for the NN-based filter. The value of the second indication being equal to 1 may indicate that a base QP plus an offset is used for the NN-based filter. The value of the second indication being equal to 2 may indicate that a base QP minus an offset is used for the NN-based filter.

It should be understood that the above examples are described merely for purpose of description. The scope of the present disclosure is not limited in this respect. For example, the one or more indications may also be implemented with a single indication.

Furthermore, whether the second indication is comprised in the bitstream may be dependent on the first indication. For example, if the first indication indicates that the NN-based filter is used for the first video block, the second indication may be comprised in the bitstream. Additionally, if the first indication indicates that the NN-based filter is not used for the first video block, the second indication may be absent from the bitstream.

In some additional embodiments, whether the one or more indications are comprised in the bitstream may be dependent on the at least one indication indicating the first information. For example, if the at least one indication indicates that information regarding the usage of the NN-based filter is determined at the first level, the one or more indications may be comprised in the bitstream. Additionally or alternatively, if the at least one indication indicates that information regarding the usage of the NN-based filter is not determined at the first level, the one or more indications may be absent from the bitstream.

Thereby, the proposed method can advantageously support adaptive usage of the NN-based filter at a lower level, such a CTU level or a CTB level, and thus the coding efficiency can be improved.

In some additional or alternative embodiments, the second information may comprise at least one of the following: which NN-based filter is used for the first video block, whether to use the NN-based filter for a Y component of the first video block, whether to use the NN-based filter for a U component of the first video block, or whether to use the NN-based filter for a V component of the first video block.

In some embodiments, whether the bitstream comprises a first set of indications indicating at least one of the following may be dependent on a first indication indicating whether to use the NN-based filter for the first video block: whether to use the NN-based filter for the Y component of the first video block, whether to use the NN-based filter for the U component of the first video block, or whether to use the NN-based filter for the V component of the first video block. By way of example, if the first indication indicates that the NN-based filter is used for the first video block, the bitstream may comprise the first set of indications. Additionally or alternatively, if the first indication indicates that the NN-based filter is not used for the first video block, the first set of indications may be absent from the bitstream.

In some embodiments, a second set of indications indicates whether to use the NN-based filter for the Y component of the first video block and whether to use the NN-based filter for the U component of the first video block. A third indication indicates whether to use the NN-based filter for the V component of the first video block. Moreover, whether the third indication is comprised in the bitstream may be dependent on the second set of indications.

For example, if the second set of indications indicates that the NN-based filter is not used for the Y component and the U component of the first video block, the third indication may be absent from the bitstream. In this case, the third indication may be inferred to indicate that the NN-based filter is used for the V component of the first video block. Furthermore, if the second set of indications indicates that the NN-based filter is used for at least one the Y component or the U component of the first video block, the third indication may be comprised in the bitstream.

In some embodiments, the second information may comprise at least one of the following: whether to use the NN-based filter for a luma component of the first video block, or whether to use the NN-based filter for a chroma component of the first video block. In this case, whether the bitstream comprises a third set of indications indicating at least one of the following may be dependent on a first indication indicating whether to use the NN-based filter for the first video block: whether to use the NN-based filter for the luma component of the first video block, or whether to use the NN-based filter for the chroma component of the first video block.

For example, if the first indication indicates that the NN-based filter is used for the first video block, the bitstream may comprise the third set of indications. Additionally or alternatively, if the first indication indicates that the NN-based filter is not used for the first video block, the third set of indications may be absent from the bitstream.

In some embodiments, a fourth indication indicates whether to use the NN-based filter for the luma component of the first video block. A fifth indication indicates whether to use the NN-based filter for the chroma component of the first video block. Moreover, whether the fifth indication is comprised in the bitstream may be dependent on the fourth indication.

For example, if the fourth indication indicates that the NN-based filter is not used for the luma component of the first video block, the fifth indication may be absent from the bitstream. In this case, the fifth indication may be inferred to indicate that the NN-based filter is used for the chroma component of the first video block. Furthermore, if the fourth indication indicates that the NN-based filter is used for the luma component of the first video block, the fifth indication may be comprised the bitstream.

In some further embodiments, the second information may further comprise at least one of the following: whether to use the NN-based filter for a U component of the first video block, or whether to use the NN-based filter for a V component of the first video block. In this case, whether the bitstream comprises a fourth set of indications indicating at least one of the following may be dependent on a fifth indication indicates whether to use the NN-based filter for the chroma component of the first video block: whether to use the NN-based filter for the U component of the first video block, or whether to use the NN-based filter for the V component of the first video block. For example, if the fifth indication indicates that the NN-based filter is used for the chroma component of the first video block, the fourth set of indications may be comprised in the bitstream. Additionally, if the fifth indication indicates that the NN-based filter is not used for the chroma component of the first video block, the fourth set of indications may be absent from the bitstream.

In some embodiments, a third indication indicates whether to use the NN-based filter for the V component of the first video block. A sixth indication indicates whether to use the NN-based filter for the U component of the first video block. Moreover, whether the third indication is comprised in the bitstream may be dependent on the sixth indication.

For example, if the sixth indication indicates that the NN-based filter is not used for the U component of the first video block, the third indication may be absent from the bitstream. In this case, the third indication may be inferred to indicate that the NN-based filter is used for the V component of the first video block. Furthermore, if the sixth indication indicates that the NN-based filter is used for the U component of the first video block, the third indication may be comprised in the bitstream.

In view of the above, the proposed method can advantageously enable flexible and efficient signaling of information on applying the NN-based filter on different color components, and thus the coding efficiency can be improved.

In some additional embodiments, at 2602, the NN-based filter is determined according to a rule. The rule indicates at least one of: different convolution types are assigned to different inputs of the NN-based filter, a convolution with kernel size is decomposed into a combination of a plurality of convolutions with smaller kernel size, which side information to be used as an input of the NN-based filter, a multi-scale neural network structure is used in the NN-based filter, a transformer-based structure is used in the NN-based filter, a non-NN-based filter is combined with the NN-based filter, or a set of parameters of the NN-based filter is adaptive.

In addition, the NN-based filter is applied to a reconstruction of the current video unit, and the conversion is performed based on a result of applying the NN-based filter. Compared with the conventional solution where filters are selected directly, the filters can be adaptively combined for the current video unit. In this way, the coding effectiveness and coding efficiency can be improved.

In some embodiments, a convolution sharing a same kernel size and different channel numbers is assigned for each input. In some embodiments, the channel numbers for each input are represented as C₁, C₂, . . . , Cₙ, where n is an integer which denotes the number of inputs.

In some embodiments, a constraint where the channel numbers for different inputs are different is added. For example, the constraint is that for indexes i and j, Cᵢ≠Cⱼ, and where 1≤i, j≤n that Cᵢ≠Cⱼ.

In some embodiments, a constraint where at least two inputs have different channel numbers. For example, the constraint is that there is at least one pair of indexes i and j, Cᵢ≠Cⱼ, and where 1≤i, j≤n.

In some embodiments, a convolution sharing a same channel numbers and different kernel sizes is assigned for each input. In some embodiments, a 1×1 kernel size is used for a convolution of a part of inputs and a K×K kernel size is used for a convolution of rest inputs, where K is an integer value greater than 1. In some other embodiments, different convolution channel numbers and different convolution kernel size are assigned for each input.

In some embodiments, a C₁×C₂×K×K convolution is decomposed into the combination of the plurality of convolutions with smaller kernel size. In this case, K represents an integer value greater than 1, C₁ and C₂ represent an input channel number and output channel number of the convolution, respectively.

In some embodiments, the input channel number and output channel number of the convolution are not changed, if the convolution is decomposed. In some embodiments, the C₁×C₂×K×K convolution is decomposed into a combination of C₁×C₂×1×K convolution followed by C₁×C₂×K×1 convolution. In some other embodiments, the C₁×C₂×K×K convolution is decomposed into a combination of C₁×C₂×1×K convolution followed by C₁×C₂×K×1 convolution, and an activation layer is placed after each convolution. In some further embodiments, the C₁×C₂×K×K convolution is decomposed into a combination of C₁×C₂×K×1 convolution followed by C₁×C₂×1×K convolution. In some other embodiments, the C₁×C₂×K×K convolution is decomposed into a combination of C₁×C₂×K×1 convolution followed by C₁×C₂×1×K convolution, and an activation layer is placed after each convolution.

In some embodiments, the input channel number and output channel number of the convolution are changed, if the convolution is decomposed. In some embodiments, the C₁×C₂×K×K convolution is decomposed into a combination of C₁×C₃×1×K convolution followed by C₃×C₂×K×1 convolution, where C₃ is a positive integer different from C₂. In some other embodiments, the C₁×C₂×K×K convolution is decomposed into a combination of C₁×C₃×1×K convolution followed by C₃×C₂×K×1 convolution, and an activation layer is placed after each convolution, where C₃ is a positive integer different with C₂. In some further embodiments, the C₁×C₂×K×K convolution is decomposed into a combination of C₁×C₃×K×1 convolution followed by C₃×C₂×1×K convolution, where C₃ is a positive integer different from C₂. In some other embodiments, the C₁×C₂×K×K convolution is decomposed into a combination of C₁×C₃×K×1 convolution followed by C₃×C₂×1×K convolution, and an activation layer is placed after each convolution, where C₃ is a positive integer different from C₂.

In some embodiments, a portion of K×K convolutions are decomposed. In some other embodiments, all K×K convolutions are decomposed.

In some embodiments, the side information is used as an extra input of the NN-based filter. For example, a slice quantization parameters (QP) is used as the extra input of the NN-based filter. In some embodiments, the slice QP is normalized by a formula of sliceQP÷MAX_QP, wherein a value of MAX_QP is 63. In some other embodiments, the slice QP is first tiled or spanned into a 2-dimensional array with the same size as the current video unit to be filtered.

In some embodiments, a base QP is used as an extra input of the NN-based filter. In some embodiments, the base QP is normalized by a formula of baseQP÷MAX_QP, wherein a value of MAX_QP is 63. In some other embodiments, the base QP is first tiled or spanned into a 2-dimensional array with the same size as the current video unit to be filtered.

In some embodiments, a prediction picture is used as an extra input of the NN-based filter. In some other embodiments, a slice type is used as an extra input of the NN-based filter. For example, the slice type is a binary value which indicates whether a picture to be filtered is intra slice. As another example, a slice type indicator is a first tiled or spanned into a 2-dimensional array with the same size as the current video unit to be filtered.

In some embodiments, IPB information of the current video unit to be filtered is used as an extra input of the NN-based filter. For example, the IPB information is derived from a slice type. In some embodiments, a value of IPB information is derived as follows: if the slice type is I slice, the value of IPB information is equal to a, if the slice type is B slice, the value of IPB information is equal to b, and if the slice type is P slice, the value of IPB information is equal to c, wherein a, b and c are constants. In some embodiments, b=c. Alternatively, or in addition, b=−a, c=−a. Alternatively, or in addition, a=1, b=−1, c=−1. Alternatively, or in addition, a=1, b=0.5, c=0.5. In some embodiments, the IPB information is first tiled or spanned into a 2-dimensional array with the same size as the current video unit to be filtered.

In some embodiments, a boundary strength of the current video unit to be filtered is used as an extra input of the NN-based filter. In some embodiments, a combination of the side information is used as the extra input of the NN-based filter.

In some embodiments, convolutions for each input side information are performed separately and then all convolution results are concatenated with an output of convolution of reconstruction picture. In some embodiments, a reconstruction picture and side information are concatenated and followed by a convolution.

In some embodiments, the multi-scale neural network structure comprises a neural network with two branches is used. In some embodiments, as shown in FIG. 16, one of the two branches comprises a C₁×C₂×K₁×K₁ convolution and an activation layer, the other branch comprises C₃×C₄×K₂×K₂ convolution and an activation layer, and where Kᵢ represents a kernel size where 1≤i≤4, Cⱼ is related to channel numbers, where 1≤j≤8.

In some embodiments, the multi-scale neural network structure that comprises a plurality of branches, a first convolution is used in a first branch of the plurality of branches and a second convolution is used in a second branch of the plurality of branches. In addition, at least one of the followings of the first convolution is different from that of the second convolution: a kernel size, a channel number, or a stride.

In some embodiments, at least one of: head, backbone or tail is determined by using a transformer network. In some other embodiments, the transformer-based structure is combined with convolutional neural network (CNN) in the NN-based filter. For example, a CNN module is followed by a transformer module in the NN-based filter. In some further embodiments, the transformer-based structure and a CNN-based structure are alternative in the NN-based filter. For example, the NN-based filters are selected, if there are two neural network-based filters which comprise a CNN-based filter and a transformer-based filter.

In some embodiments, the non-NN-based filter is a deblocking filter (DBF). In some other embodiments, the non-NN-based filter is a sample adaptive offset (SAO) filter. Alternatively, the non-NN-based filter is a combination of DBF and SAO filter.

In some embodiments, the NN-based filter and a DBF are combined. In some embodiments, an SAO filter is after the combination of the NN-based filter and the DBF. For example, the SAO filter is enabled or disabled by a syntax element.

In some embodiments, an adaptive loop filter (ALF) is used after an SAO filter. In some embodiments, the ALF is enabled or disabled by a syntax element.

In some embodiments, the NN-based filter and a combination of DBF and SAO filter are combined. For example, an ALF is used after the combination of the NN-based filter and the combination of DBF and SAO filter. In some embodiments, the ALF is enabled or disabled by a syntax element.

In some embodiments, reconstruction samples of the non-NN-based filter and the NN-based filter are combined by a scaling factor. In some embodiments, the reconstruction samples are combined in slice level or block level. In some embodiments, the scaling factor is adaptive and is determined by video content. In some other embodiments, the scaling factor is pre-defined.

In some embodiments, the scaling factor is separated for different components. For example, the scaling factor is separated for luma and chroma components. Alternatively, or in addition, the scaling factor is separated for U and V components.

In some embodiments, a candidate list comprising a plurality of input parameters is used. In some embodiments, the number of candidates in the candidate list is configurable in sequence level or slice level or block level.

In some embodiments, the candidate list is constructed in sequence level or slice level or block level. In some other embodiments, the candidate list is adaptive for sequence level or slice level or block level.

In some embodiments, an input parameter is a variable dependent on base QP which is denoted as q. For example, q is QP in sequence level or slice level or block level.

In some embodiments, the candidate list comprises a base QP and adjusted QP. In some embodiments, the adjusted QP is equal to the base QP by adding an offset. In some embodiments, the offset is equal to one of −5, 10, 5. In some other embodiments, the offset is dependent on a thread identity (TID) level.

In some embodiments, an inference granularity or size of NN-based filter is adaptive for one of: sequence level, slice level, or block level. In some embodiments, the inference granularity or size is dependent on a slice type. In some other embodiments, the inference granularity or size is configurable dependent on a syntax element in one of: sequence level, slice level, or block level.

In some embodiments, at least one of: block extension or padding size is adaptive for one of: sequence level, slice level, or block level. In some embodiments, at least one of: block extension or padding size dependent on block modes and/or slice type. In some other embodiments, at least one of: block extension or padding size is configurable dependent on a syntax element in one of: sequence level, slice level, or block level.

In some embodiments, at 2602, the NN-based filter is determined. The NN-based filter comprises a multi-scale neural network structure that comprises a plurality of branches. Moreover, the NN-based filter is applied to the current video unit, and the conversion is performed based on the filtered video unit. Compared with the conventional solution where filters are selected directly, the filters can be adaptively combined for the current video unit. In this way, the coding effectiveness and coding efficiency can be improved.

In some embodiments, the NN-based filter comprises a combination of a plurality of convolutions with smaller kernel size. For example, the convolution with kernel size K×K is decomposed into the plurality of convolutions with smaller kernel size.

In some embodiments, a first convolution is used in a first branch of the plurality of branches and a second convolution is used in a second branch of the plurality of branches. At least one of the followings of the first convolution may be different from that of the second convolution: a kernel size, a channel number, or a stride. In one example, neural network with multiple branches may be used. In each branch, different convolution with different kernel size, channel number, or stride might be used.

In some embodiments, an activation layer is used in the NN-based filter. In some embodiments, the activation layer is used after all convolution layers, or wherein the activation layer is used after a part of convolution layers. In some embodiments, the activation layer is a PRelu layer, or wherein the activation layer is a Relu layer. In some embodiments, a residual connection is used.

In some embodiments, the multi-scale neural network structure is used as a basic block in the NN-based filter. In some embodiments, the basic block is used for a predetermined number of times. The predetermined number may be an integer greater than 0.

In some embodiments, the basic block is used together with other blocks. In some embodiments, the basic block is used together with other convolution layer and activation layer, and/or wherein the basic block is used together with a residual block.

In some embodiments, the NN-based filter is used for at least one of: luma component or chroma component. Alternatively, or in addition, the NN-based filter is used for at least one of: intra slice or inter slice.

In some embodiments, an output of the NN-based filter comprises luma components, or chroma components. Alternatively, an output of the NN-based filter comprises both luma and chroma components. In some embodiments, a first NN-based filter is used for generating an output of luma component and a second NN-based filter is used for generating an output of chroma component, respectively.

In some embodiments, a first number of models are used for generating an output of luma component, and a second number of models are used for generating an output of chroma component. In this case, both the first number and the second number may be integers greater than 0. In some embodiments, Cb and Cr components share a same chroma model of the NN-based filter.

In some embodiments, a single NN-based filter is used for generating an output of luma component and an output of chroma component. In some embodiments, a third number of models are used, and for each model, outputs of luma component and chroma component are generated, where M1 is an integer greater than 0.

In some embodiments, the outputs of luma and chroma components generated by the single NN-based filter are used together. In some other embodiments, the outputs of luma and chroma components generated by the single NN-based filter are used separately.

In some embodiments, the output of luma component generated by the single neural network is used and the output of chroma component generated by the NN-based filter is not used. In some embodiments, the output of luma component generated by the single neural network is not used and the output of chroma component generated by the NN-based filter is used.

In some embodiments, a single NN-based filter is used for generating filtered outputs for both intra and inter slices. In some embodiments, the intra slice is I slice. In some embodiments, the inter slice is one of: B slice, or P slice, or B and P slices.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a bitstream of a video which is generated by a method performed by an apparatus for video processing. In the method, a conversion between a current video unit of the video and the bitstream is performed. The bitstream comprises at least one indication indicating first information regarding a usage of a neural network (NN) based filter for the current video unit, and the NN-based filter is configured to process a luma component and a chroma component of the current video unit.

According to still further embodiments of the present disclosure, a method for storing bitstream of a video is provided. In the method, a conversion between a current video unit of the video and the bitstream is performed. The bitstream comprises at least one indication indicating first information regarding a usage of a neural network (NN) based filter for the current video unit, and the NN-based filter is configured to process a luma component and a chroma component of the current video unit. Furthermore, the bitstream is stored in a non-transitory computer-readable recording medium.

Implementations of the present disclosure can be described in view of the following clauses, the features of which can be combined in any reasonable manner.
Clause 1. A method for video processing, comprising: performing a conversion between a current video unit of a video and a bitstream of the video, wherein the bitstream comprises at least one indication indicating first information regarding a usage of a neural network (NN) based filter for the current video unit, and the NN-based filter is configured to process a luma component and a chroma component of the current video unit.
Clause 2. The method of clause 1, wherein the current video unit comprises a slice.
Clause 3. The method of any of clauses 1-2, wherein the first information comprises at least one of the following: whether to use the NN-based filter for the current video unit, at least one parameter for the NN-based filter that is used for the current video unit, or whether information regarding the usage of the NN-based filter is determined at a first level lower than a level of the current video unit.
Clause 4. The method of clause 3, wherein the at least one parameter comprises a quantization parameter (QP).
Clause 5. The method of any of clauses 3-4, wherein the first level is a coding tree unit (CTU) level or a coding tree block (CTB) level.
Clause 6. The method of any of clauses 1-5, wherein the at least one indication comprises a single indication.
Clause 7. The method of any of clauses 1-6, wherein the current video unit comprises a plurality of video blocks at a first level lower than a level of the current video unit, and one or more indications indicate second information regarding a usage of the NN-based filter for a first video block of the plurality of video blocks.
Clause 8. The method of clause 7, wherein the second information comprises at least one of the following: whether to use the NN-based filter for the first video block, or one or more parameters for the NN-based filter that are used for the first video block.
Clause 9. The method of clause 8, wherein the one or more indications comprise: a first indication indicating whether to use the NN-based filter for the first video block, and a second indication indicating the one or more parameters.
Clause 10. The method of clause 9, wherein whether the second indication is comprised in the bitstream is dependent on the first indication.
Clause 11. The method of clause 10, wherein if the first indication indicates that the NN-based filter is used for the first video block, the second indication is comprised in the bitstream.
Clause 12. The method of any of clauses 8-11, wherein the one or more parameters comprise a quantization parameter (QP).
Clause 13. The method of any of clauses 7-12, wherein the first level is a CTU level, and the first video block comprises a CTU, or wherein the first level is a CTB level, and the video block comprises a CTB.
Clause 14. The method of any of clauses 7-13, wherein whether the one or more indications are comprised in the bitstream is dependent on the at least one indication.
Clause 15. The method of clause 14, wherein if the at least one indication indicates that information regarding the usage of the NN-based filter is determined at the first level, the one or more indications are comprised in the bitstream.
Clause 16. The method of any of clauses 1-15, wherein the first information comprises at least one of the following: which NN-based filter is used for the current video unit, whether to use the NN-based filter for a Y component of the current video unit, whether to use the NN-based filter for a U component of the current video unit, or whether to use the NN-based filter for a V component of the current video unit.
Clause 17. The method of clause 16, wherein whether the bitstream comprises one or more indications indicating at least one of the following is dependent on an indication indicating whether to use the NN-based filter for the current video unit: whether to use the NN-based filter for a Y component of the current video unit, whether to use the NN-based filter for a U component of the current video unit, or whether to use the NN-based filter for a V component of the current video unit.
Clause 18. The method of any of clauses 7-17, wherein the second information comprises at least one of the following: which NN-based filter is used for the first video block, whether to use the NN-based filter for a Y component of the first video block, whether to use the NN-based filter for a U component of the first video block, or whether to use the NN-based filter for a V component of the first video block.
Clause 19. The method of clause 18, wherein whether the bitstream comprises a first set of indications indicating at least one of the following is dependent on a first indication indicating whether to use the NN-based filter for the first video block: whether to use the NN-based filter for the Y component of the first video block, whether to use the NN-based filter for the U component of the first video block, or whether to use the NN-based filter for the V component of the first video block.
Clause 20. The method of clause 19, wherein if the first indication indicates that the NN-based filter is used for the first video block, the bitstream comprises the first set of indications.
Clause 21. The method of any of clauses 19-20, wherein if the first indication indicates that the NN-based filter is not used for the first video block, the first set of indications is absent from the bitstream.
Clause 22. The method of any of clauses 18-21, wherein a second set of indications indicates whether to use the NN-based filter for the Y component of the first video block and whether to use the NN-based filter for the U component of the first video block, a third indication indicates whether to use the NN-based filter for the V component of the first video block, and whether the third indication is comprised in the bitstream is dependent on the second set of indications.
Clause 23. The method of clause 22, wherein if the second set of indications indicates that the NN-based filter is not used for the Y component and the U component of the first video block, the third indication is absent from the bitstream.
Clause 24. The method of any of clauses 22-23, wherein if the second set of indications indicates that the NN-based filter is used for at least one the Y component or the U component of the first video block, the third indication is comprised in the bitstream.
Clause 25. The method of any of clauses 7-24, wherein the second information comprises at least one of the following: whether to use the NN-based filter for a luma component of the first video block, or whether to use the NN-based filter for a chroma component of the first video block.
Clause 26. The method of clause 25, wherein whether the bitstream comprises a third set of indications indicating at least one of the following is dependent on a first indication indicating whether to use the NN-based filter for the first video block: whether to use the NN-based filter for the luma component of the first video block, or whether to use the NN-based filter for the chroma component of the first video block.
Clause 27. The method of clause 26, wherein if the first indication indicates that the NN-based filter is used for the first video block, the bitstream comprises the third set of indications.
Clause 28. The method of any of clauses 26-27, wherein if the first indication indicates that the NN-based filter is not used for the first video block, the third set of indications is absent from the bitstream.
Clause 29. The method of any of clauses 25-28, wherein a fourth indication indicates whether to use the NN-based filter for the luma component of the first video block, a fifth indication indicates whether to use the NN-based filter for the chroma component of the first video block, and whether the fifth indication is comprised in the bitstream is dependent on the fourth indication.
Clause 30. The method of clause 29, wherein if the fourth indication indicates that the NN-based filter is not used for the luma component of the first video block, the fifth indication is absent from the bitstream.
Clause 31. The method of any of clauses 29-30, wherein if the fourth indication indicates that the NN-based filter is used for the luma component of the first video block, the fifth indication is comprised the bitstream.
Clause 32. The method of any of clauses 25-31, wherein the second information further comprises at least one of the following: whether to use the NN-based filter for a U component of the first video block, or whether to use the NN-based filter for a V component of the first video block.
Clause 33. The method of clause 32, wherein whether the bitstream comprises a fourth set of indications indicating at least one of the following is dependent on a fifth indication indicates whether to use the NN-based filter for the chroma component of the first video block: whether to use the NN-based filter for the U component of the first video block, or whether to use the NN-based filter for the V component of the first video block.
Clause 34. The method of clause 33, wherein if the fifth indication indicates that the NN-based filter is used for the chroma component of the first video block, the fourth set of indications is comprised in the bitstream.
Clause 35. The method of any of clauses 33-34, wherein if the fifth indication indicates that the NN-based filter is not used for the chroma component of the first video block, the fourth set of indications is absent from the bitstream.
Clause 36. The method of any of clauses 32-35, wherein a third indication indicates whether to use the NN-based filter for the V component of the first video block, a sixth indication indicates whether to use the NN-based filter for the U component of the first video block, and whether the third indication is comprised in the bitstream is dependent on the sixth indication.
Clause 37. The method of clause 36, wherein if the sixth indication indicates that the NN-based filter is not used for the U component of the first video block, the third indication is absent from the bitstream.
Clause 38. The method of any of clauses 36-37, wherein if the sixth indication indicates that the NN-based filter is used for the U component of the first video block, the third indication is comprised in the bitstream.
Clause 39. The method of any of clauses 1-38, wherein an indication comprises a syntax element.
Clause 40. The method of any of clauses 1-39, wherein performing the conversion comprises: determining the NN-based filter according to a rule, wherein the rule indicates at least one of: different convolution types are assigned to different inputs of the NN-based filter, a convolution with kernel size is decomposed into a combination of a plurality of convolutions with smaller kernel size, which side information to be used as an input of the NN-based filter, a multi-scale neural network structure is used in the NN-based filter, a transformer-based structure is used in the NN-based filter, a non-NN-based filter is combined with the NN-based filter, or a set of parameters of the NN-based filter is adaptive: applying the NN-based filter to a reconstruction of the current video unit; and performing the conversion based on the applying.
Clause 41. The method of clause 40, wherein a convolution sharing a same kernel size and different channel numbers is assigned for each input.
Clause 42. The method of clause 40, wherein a convolution sharing a same channel numbers and different kernel sizes is assigned for each input.
Clause 43. The method of clause 40, wherein different convolution channel numbers and different convolution kernel size are assigned for each input.
Clause 44. The method of clause 40, wherein a C₁×C₂×K×K convolution is decomposed into the combination of the plurality of convolutions with smaller kernel size, wherein K represents an integer value greater than 1, C₁ and C₂ represent an input channel number and output channel number of the convolution, respectively.
Clause 45. The method of clause 44, wherein the input channel number and output channel number of the convolution are not changed, if the convolution is decomposed.
Clause 46. The method of clause 44, wherein the input channel number and output channel number of the convolution are changed, if the convolution is decomposed.
Clause 47. The method of clause 44, wherein a portion of K×K convolutions are decomposed.
Clause 48. The method of clause 44, wherein all K×K convolutions are decomposed.
Clause 49. The method of clause 40, wherein the side information is used as an extra input of the NN-based filter.
Clause 50. The method of clause 49, wherein a slice QP is used as the extra input of the NN-based filter.
Clause 51. The method of clause 49, wherein a base QP is used as an extra input of the NN-based filter.
Clause 52. The method of clause 49, wherein a prediction picture is used as an extra input of the NN-based filter.
Clause 53. The method of clause 49, wherein a slice type is used as an extra input of the NN-based filter.
Clause 54. The method of clause 49, wherein IPB information of the current video unit to be filtered is used as an extra input of the NN-based filter.
Clause 55. The method of clause 49, wherein a boundary strength of the current video unit to be filtered is used as an extra input of the NN-based filter.
Clause 56. The method of any of clauses 49-55, wherein a combination of the side information is used as the extra input of the NN-based filter.
Clause 57. The method of clause 40, wherein convolutions for each input side information are performed separately and then all convolution results are concatenated with an output of convolution of reconstruction picture.
Clause 58. The method of clause 40, wherein a reconstruction picture and side information are concatenated and followed by a convolution.
Clause 59. The method of clause 40, wherein the multi-scale neural network structure comprises a neural network with two branches is used, one of the two branches comprises a C₁×C₂×K₁×K₁ convolution and an activation layer, the other branch comprises C₃×C₄×K₂×K₂ convolution and an activation layer, and wherein Kᵢ represents a kernel size where 1≤i≤4, Cⱼ is related to channel numbers, where 1≤j≤8.
Clause 60. The method of clause 40, wherein the multi-scale neural network structure that comprises a plurality of branches, a first convolution is used in a first branch of the plurality of branches and a second convolution is used in a second branch of the plurality of branches, and at least one of the followings of the first convolution is different from that of the second convolution: a kernel size, a channel number, or a stride.
Clause 61. The method of clause 40, wherein at least one of: head, backbone or tail is determined by using a transformer network.
Clause 62. The method of clause 40, wherein the transformer-based structure is combined with convolutional neural network (CNN) in the NN-based filter.
Clause 63. The method of clause 62, wherein a CNN module is followed by a transformer module in the NN-based filter.
Clause 64. The method of clause 40, wherein the transformer-based structure and a CNN-based structure are alternative in the NN-based filter.
Clause 65. The method of clause 64, wherein the NN-based filter is selected, if there are two neural network-based filters which comprise a CNN-based filter and a transformer-based filter.
Clause 66. The method of clause 40, wherein the non-NN-based filter is a deblocking filter (DBF), or wherein the non-NN-based filter is a sample adaptive offset (SAO) filter, or wherein the non-NN-based filter is a combination of DBF and SAO filter.
Clause 67. The method of clause 40, wherein the NN-based filter and a DBF are combined.
Clause 68. The method of clause 40, wherein the NN-based filter and a combination of DBF and SAO filter are combined.
Clause 69. The method of clause 40, wherein reconstruction samples of the non-NN-based filter and the NN-based filter are combined by a scaling factor.
Clause 70. The method of clause 69, wherein the reconstruction samples are combined in slice level or block level.
Clause 71. The method of clause 69, wherein the scaling factor is adaptive and is determined by video content.
Clause 72. The method of clause 69, wherein the scaling factor is pre-defined.
Clause 73. The method of clause 69, wherein the scaling factor is separated for different components.
Clause 74. The method of clause 40, wherein a candidate list comprising a plurality of input parameters is used.
Clause 75. The method of clause 74, wherein the number of candidates in the candidate list is configurable in sequence level or slice level or block level.
Clause 76. The method of clause 74, wherein the candidate list is constructed in sequence level or slice level or block level.
Clause 77. The method of clause 74, wherein the candidate list is adaptive for sequence level or slice level or block level.
Clause 78. The method of clause 74, wherein an input parameter is a variable dependent on base QP which is denoted as q.
Clause 79. The method of clause 74, wherein the candidate list comprises a base QP and adjusted QP.
Clause 80. The method of clause 40, wherein an inference granularity or size of NN-based filter is adaptive for one of: sequence level, slice level, or block level.
Clause 81. The method of clause 80, wherein the inference granularity or size is dependent on a slice type.
Clause 82. The method of clause 80, wherein the inference granularity or size is configurable dependent on a syntax element in one of: sequence level, slice level, or block level.
Clause 83. The method of clause 40, wherein at least one of: block extension or padding size is adaptive for one of: sequence level, slice level, or block level.
Clause 84. The method of clause 80, wherein at least one of: block extension or padding size dependent on block modes and/or slice type.
Clause 85. The method of clause 80, wherein at least one of: block extension or padding size is configurable dependent on a syntax element in one of: sequence level, slice level, or block level.
Clause 86. The method of any of clauses 1-85, wherein the NN-based filter is used for generating filtered outputs for both intra and inter slices.
Clause 87. The method of clause 86, wherein the intra slice is I slice.
Clause 88. The method of clause 86, wherein the inter slice is one of: B slice, or P slice, or B and P slices.
Clause 89. The method of any of clauses 1-88, wherein the conversion includes encoding the current video unit into the bitstream.
Clause 90. The method of any of clauses 1-88, wherein the conversion includes decoding the current video unit from the bitstream.
Clause 91. An apparatus for video processing comprising a processor and a non-transitory memory with instructions thereon, wherein the instructions upon execution by the processor, cause the processor to perform a method in accordance with any of clauses 1-90.
Clause 92. A non-transitory computer-readable storage medium storing instructions that cause a processor to perform a method in accordance with any of clauses 1-90.
Clause 93. A non-transitory computer-readable recording medium storing a bitstream of a video which is generated by a method performed by an apparatus for video processing, wherein the method comprises: performing a conversion between a current video unit of the video and the bitstream, wherein the bitstream comprises at least one indication indicating first information regarding a usage of a neural network (NN) based filter for the current video unit, and the NN-based filter is configured to process a luma component and a chroma component of the current video unit.
Clause 94. A method for storing a bitstream of a video, comprising: performing a conversion between a current video unit of the video and the bitstream, wherein the bitstream comprises at least one indication indicating first information regarding a usage of a neural network (NN) based filter for the current video unit, and the NN-based filter is configured to process a luma component and a chroma component of the current video unit; and storing the bitstream in a non-transitory computer-readable recording medium.

### Example Device

FIG. 27 illustrates a block diagram of a computing device 2700 in which various embodiments of the present disclosure can be implemented. The computing device 2700 may be implemented as or included in the source device 110 (or the video encoder 114 or 200) or the destination device 120 (or the video decoder 124 or 300).

It would be appreciated that the computing device 2700 shown in FIG. 27 is merely for purpose of illustration, without suggesting any limitation to the functions and scopes of the embodiments of the present disclosure in any manner.

As shown in FIG. 27, the computing device 2700 includes a general-purpose computing device 2700. The computing device 2700 may at least comprise one or more processors or processing units 2710, a memory 2720, a storage unit 2730, one or more communication units 2740, one or more input devices 2750, and one or more output devices 2760.

In some embodiments, the computing device 2700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2700 can support any type of interface to a user (such as “wearable” circuitry and the like).

The processing unit 2710 may be a physical or virtual processor and can implement various processes based on programs stored in the memory 2720. In a multi-processor system, multiple processing units execute computer executable instructions in parallel so as to improve the parallel processing capability of the computing device 2700. The processing unit 2710 may also be referred to as a central processing unit (CPU), a microprocessor, a controller or a microcontroller.

The computing device 2700 typically includes various computer storage medium. Such medium can be any medium accessible by the computing device 2700, including, but not limited to, volatile and non-volatile medium, or detachable and non-detachable medium. The memory 2720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2730 may be any detachable or non-detachable medium and may include a machine-readable medium such as a memory, flash memory drive, magnetic disk or another other media, which can be used for storing information and/or data and can be accessed in the computing device 2700).

The computing device 2700 may further include additional detachable/non-detachable, volatile/non-volatile memory medium. Although not shown in FIG. 27, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2740) communicates with a further computing device via the communication medium. In addition, the functions of the components in the computing device 2700 can be implemented by a single computing cluster or multiple computing machines that can communicate via communication connections. Therefore, the computing device 2700 can operate in a networked environment using a logical connection with one or more other servers, networked personal computers (PCs) or further general network nodes.

The input device 2750 may be one or more of a variety of input devices, such as a mouse, keyboard, tracking ball, voice-input device, and the like. The output device 2760 may be one or more of a variety of output devices, such as a display, loudspeaker, printer, and the like. By means of the communication unit 2740, the computing device 2700 can further communicate with one or more external devices (not shown) such as the storage devices and display device, with one or more devices enabling the user to interact with the computing device 2700, or any devices (such as a network card, a modem and the like) enabling the computing device 2700 to communicate with one or more other computing devices, if required. Such communication can be performed via input/output (I/O) interfaces (not shown).

In some embodiments, instead of being integrated in a single device, some or all components of the computing device 2700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2700 may be used to implement video encoding/decoding in embodiments of the present disclosure. The memory 2720 may include one or more video coding modules 2725 having one or more program instructions. These modules are accessible and executable by the processing unit 2710 to perform the functionalities of the various embodiments described herein.

In the example embodiments of performing video encoding, the input device 2750 may receive video data as an input 2770 to be encoded. The video data may be processed, for example, by the video coding module 2725, to generate an encoded bitstream. The encoded bitstream may be provided via the output device 2760 as an output 2780.

In the example embodiments of performing video decoding, the input device 2750 may receive an encoded bitstream as the input 2770. The encoded bitstream may be processed, for example, by the video coding module 2725, to generate decoded video data. The decoded video data may be provided via the output device 2760 as the output 2780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
performing a conversion between a current video unit of a video and a bitstream of the video, wherein the bitstream comprises at least one indication indicating first information regarding a usage of a neural network (NN) based filter for the current video unit, and the NN-based filter is configured to process a luma component and a chroma component of the current video unit.

2. The method of claim 1, wherein the current video unit comprises a slice.

3. The method of claim 1, wherein the first information comprises at least one of the following:
whether to use the NN-based filter for the current video unit,
at least one parameter for the NN-based filter that is used for the current video unit, or
whether information regarding the usage of the NN-based filter is determined at a first level lower than a level of the current video unit.

4. The method of claim 3, wherein the at least one parameter comprises a quantization parameter (QP).

5. The method of claim 3, wherein the first level is a coding tree unit (CTU) level or a coding tree block (CTB) level.

6. The method of claim 1, wherein the at least one indication comprises a single indication.

7. The method of claim 1, wherein the current video unit comprises a plurality of video blocks at a first level lower than a level of the current video unit, and one or more indications indicate second information regarding a usage of the NN-based filter for a first video block of the plurality of video blocks.

8. The method of claim 7, wherein the second information comprises at least one of the following:
whether to use the NN-based filter for the first video block, or
one or more parameters for the NN-based filter that are used for the first video block.

9. The method of claim 8, wherein the one or more indications comprise:
a first indication indicating whether to use the NN-based filter for the first video block, and
a second indication indicating the one or more parameters.

10. The method of claim 9, wherein whether the second indication is comprised in the bitstream is dependent on the first indication.

11. The method of claim 10, wherein if the first indication indicates that the NN-based filter is used for the first video block, the second indication is comprised in the bitstream.

12. The method of claim 8, wherein the one or more parameters comprise a quantization parameter (QP).

13. The method of claim 7, wherein the first level is a CTU level, and the first video block comprises a CTU, or
wherein the first level is a CTB level, and the video block comprises a CTB.

14. The method of claim 7, wherein whether the one or more indications are comprised in the bitstream is dependent on the at least one indication.

15. The method of claim 14, wherein if the at least one indication indicates that information regarding the usage of the NN-based filter is determined at the first level, the one or more indications are comprised in the bitstream.

16. The method of claim 1, wherein the conversion includes encoding the current video unit into the bitstream.

17. The method of claim 1, wherein the conversion includes decoding the current video unit from the bitstream.

18. An apparatus for video processing comprising a processor and a non-transitory memory with instructions thereon, wherein the instructions upon execution by the processor, cause the processor to perform acts comprising:
performing a conversion between a current video unit of a video and a bitstream of the video, wherein the bitstream comprises at least one indication indicating first information regarding a usage of a neural network (NN) based filter for the current video unit, and the NN-based filter is configured to process a luma component and a chroma component of the current video unit.

19. A non-transitory computer-readable storage medium storing instructions that cause a processor to perform acts comprising:
performing a conversion between a current video unit of a video and a bitstream of the video, wherein the bitstream comprises at least one indication indicating first information regarding a usage of a neural network (NN) based filter for the current video unit, and the NN-based filter is configured to process a luma component and a chroma component of the current video unit.

20. A non-transitory computer-readable recording medium storing a bitstream of a video which is generated by a method performed by an apparatus for video processing, wherein the method comprises:
performing a conversion between a current video unit of the video and the bitstream, wherein the bitstream comprises at least one indication indicating first information regarding a usage of a neural network (NN) based filter for the current video unit, and the NN-based filter is configured to process a luma component and a chroma component of the current video unit.
